(19) United States
(12) Patent Application Publication
(10) Pub. No.: US 2017/0161819 A1
(43) Pub. Date: Jun. 8, 2017

(54) RELIABLE, ROBUST AND STRUCTURED DUPLEX COMMUNICATION INFRASTRUCTURE FOR MOBILE QUICK SERVICE TRANSACTIONS

(71) Applicant: AVANTI COMMERCE INC., Vancouver (CA)

(72) Inventors: Jason STRASHEK, Vancouver (CA); Timmothy Steven VARGA, Vancouver (CA); Wai Yew LEE, Vancouver (CA); Victor Shih Kwan JANG, Vancouver (CA); Stevan STANISIC, Vancouver (CA)

(73) Assignee: AVANTI COMMERCE INC., Vancouver, BC (CA)

(21) Appl. No.: 15/325,439

(22) PCT Filed: Jul. 9, 2015
(86) PCT No.: PCT/CA2015/050640

§ 371 Date: Jan. 10, 2017

Related U.S. Application Data
(60) Provisional application No. 62/023,562, filed on Jul. 11, 2014.

(51) Int. Cl. G06Q 30/06; G06Q 20/40; G06Q 20/20; G06Q 10/10

(52) U.S. Cl. CPC G06Q 30/0635; G06Q 10/1097; G06Q 20/4012; G06Q 20/202; H04L 5/14

(57) ABSTRACT

The present invention relates to a way to provide computing and communication infrastructure to support full duplex quality of service for urgent and actionable structured communications securely transacted over a many-to-many managed network of intermittent ad hoc nodes. The invention overcomes technical challenges associated with high-volume, short-latency, semi-custom mobile order fulfillment by ensuring communications between customer and merchant are structured, robust, reliable and delivered via a duplex link. The described embodiments are advantageous in that they provide a bidirectional channel to facilitate discussion, confirmation and post-order communication. Moreover, the present invention is scalable to a many-to-many node ad-hoc network.

### CROSS REFERENCE TO RELATED APPLICATIONS

This application claims priority from U.S. Provisional Patent Application Ser. No. 62/023,562 filed on Jul. 11, 2014, entitled “METHOD AND SYSTEM FOR PROVIDING FULL DUPLEX QUALITY OF SERVICE FOR URGENT AND ACTIONABLE STRUCTURED COMMUNICATIONS SECURELY TRANSACTED OVER A MANY-TO-MANY MANAGED NETWORK OF INTERMITTENT AD HOC NODES”, which is expressly incorporated by reference herein to the fullest extent permitted by law.

### BACKGROUND

Field

The present invention relates to methods and systems for providing quality of service for urgent communications transacted over a many to many ad hoc network of intermittent nodes, finding practical application for example in the quick service restaurant sector.

Description of Related Art

A significant portion of the marketplace comprises quick service transactions, for example transactions in the quick service restaurant sector. These transactions are characterized by high volume, short latency, high expectations for accurate but semi-custom fulfillment, and increasingly remote—or even mobile—order placement.

Conventionally, merchants have received such remote orders via telephone call, voice message, text message, facsimile, email, or more recently a web server or a custom application on a Point of Sale (POS) device.

In such transactions, there are many decisions to explore, clarify, negotiate, act upon, report progress on, and perhaps renegotiate throughout the interval between order placement and order fulfillment.

The conventional communication infrastructures do not conveniently support such rich, fluid yet structured decision-making. Some of these conventional arrangements provide only unidirectional communication, providing no or limited opportunity for discussion or even confirmation that an order was received. Other such conventional arrangements provide a communication channel only during order placement, and don't facilitate post-order communication. Still other such conventional arrangements are not scalable for many customers or many merchants.

What is desirable would be communication infrastructure that provides:
duplex communication between customer and merchant during the ordering process, through to, and in follow up to, fulfillment of the order,
structured communication to keep discussions focused on fulfillable transactions,
reliable communication so participants can rely that others have timely received their communications unless alerted otherwise, and
robust communication so participants can expect that the communication infrastructure will be available when needed.

### SUMMARY

The present invention is directed to these needs.

According to one aspect of the present invention, there is provided a method of fulfilling an order for at least one of a good and a service, comprising:
a. at a remote ordering platform (ROP) server, opening a first communication channel with a merchant terminal having a location, in response to receiving at the ROP server a request from the merchant terminal to open the first communication channel,
b. at the ROP server, opening a second communication channel with a customer device, in response to receiving at the ROP server a request from the customer device to open the second communication channel,
c. receiving at the ROP server an order for fulfillment from the customer device via the second communication channel,
d. sending the order from the ROP server to the merchant terminal via the first communication channel,
e. monitoring at the ROP server for receipt within a first threshold interval of an order acceptance message from the merchant terminal via the first communication channel,
f. in response to receiving at the ROP server an order acceptance message from the merchant terminal within the first threshold interval, sending an acceptance notification message from the ROP server to the customer device via the second communication channel, but in response to not receiving at the ROP server an order acceptance message from the merchant terminal within the first threshold interval, sending an order failure message from the ROP server to the customer device via the second communication channel,
g. in response to receiving at the ROP server an order acceptance message from the merchant terminal within the first threshold interval, monitoring at the ROP server for confirmation within a second threshold interval from at least one of the merchant terminal and the customer device of order fulfillment at the location, and
h. in response to receiving at the ROP server confirmation within the second threshold interval of order fulfillment, closing the second communication channel, but in response to not receiving at the ROP server confirmation within the second threshold interval of order fulfillment, sending an order failure message from the ROP server to the customer device via the second communication channel.

According to aspects of the present invention, there is provided a method of connecting a merchant terminal to a ROP server for two way communication. The workload for communicating directly to merchant terminals is distributed in the ROP servers across multiple computing resources, including geography, CPU, networks, storage, memory, IO throughput, latency and availability. Preference between the plurality of distributed hosts may be determined through a number of factors such as, but not limited to, priority, least used resource, performance, and/or affinity, as effective to provide scalability and resilience, whether through load balancing, cloud or other technologies.

According to one aspect of the present invention, there is provided a method of connecting a merchant terminal to a remote ordering platform (ROP) server for communication therebetween, the ROP server having a load balancer and a plurality of distributed hosts, comprising:
a. sending from the merchant terminal a GetHostList message to the load balancer,
b. at the merchant terminal, receiving from the load balancer a PriorityListofHosts message that provides a plurality of uniform resource identifiers respectively associated with the plurality of distributed hosts, the plurality of uniform resource identifiers being prioritized such that higher priority uniform resource identifier are more likely than lower priority uniform resource identifiers to represent an efficient connection,
c. in order of priority, sending from the merchant terminal an authorization request to the one of the plurality of distributed hosts associated with a one of the plurality of uniform resource identifiers and waiting a first interval to receive an authentication acknowledgement, and
   i. if an authentication acknowledgement is received within the first interval, opening a connection with that one of the plurality of distributed hosts, but
   ii. if an authentication acknowledgement is not received within the first interval, repeating step c. with the next highest priority one of the plurality of uniform resource identifiers, but
   iii. if an authentication acknowledgement is not received within the first interval and there is not an untried one of the plurality of uniform resource identifiers, then repeating step a., and
d. if a connection with one of the plurality of distributed hosts has been opened, monitoring at the merchant terminal for a periodic KeepAlive message from the one of the plurality of distributed hosts and in response sending to the one of the plurality of distributed hosts an Okay acknowledgement to keep open the communication channel.

According to another aspect of the present invention, there is provided a method of connecting a merchant terminal to a remote ordering platform (ROP) server for communication therebetween over a network, the ROP server having a load balancer and a plurality of distributed hosts, comprising:
a. receiving at the load balancer a GetHostList message from the merchant terminal,
b. sending from the load balancer to the merchant terminal a PriorityListofHosts message that provides a plurality of uniform resource identifiers respectively associated with the plurality of distributed hosts, the plurality of uniform resource identifiers being prioritized such that higher priority uniform resource identifier are more likely than lower priority uniform resource identifiers to represent an efficient connection,
c. in order of priority, receiving from the merchant terminal an authorization request at a one of the plurality of distributed hosts associated with a one of the plurality of uniform resource identifiers, sending an authentication acknowledgement to the merchant terminal, and opening a connection with the merchant terminal, and
d. sending from the one of the plurality of distributed hosts to the merchant terminal a periodic KeepAlive message and in response to receiving an Okay acknowledgement within a first interval keeping open the communication channel but in response to not receiving an Okay acknowledgement within the first interval closing the communication channel.

According to another aspect of the present invention, there is provided an apparatus for providing a remote ordering platform (ROP), comprising:
a. a database server operable to retrievably store information related to an order,
b. an ordering portal node, operable to receive the order from a customer device,
c. a scheduler node, operable to schedule the received order, and
d. a host node, operable to send the scheduled order to a merchant terminal.

According to another aspect of the present invention, there is provided an apparatus for providing a merchant terminal for communication with a remote ordering platform (ROP) server, comprising:
a. a computing and communication device having:
   i. a processor,
   ii. a memory for storing code for instructing the processor, and
   iii. a communication socket, and
b. ROP API component code stored in the memory to instruct the processor in communication with the ROP server via the communication socket.

According to another aspect of the present invention, there is provided a medium encoding instructions, which are readable and executable by a computing or communication device, for performing a method of fulfilling an order for at least one of a good and a service, comprising:
a. at a remote ordering platform (ROP) server, opening a first communication channel with a merchant terminal having a location, in response to receiving at the ROP server a request from the merchant terminal to open the first communication channel,
b. at the ROP server, opening a second communication channel with a customer device, in response to receiving at the ROP server a request from the customer device to open the second communication channel,
c. receiving at the ROP server an order for fulfillment from the customer device via the second communication channel,
d. sending the order from the ROP server to the merchant terminal via the first communication channel,
e. monitoring at the ROP server for receipt within a first threshold interval of an order acceptance message from the merchant terminal via the first communication channel,
f. in response to receiving at the ROP server an order acceptance message from the merchant terminal within the first threshold interval, sending an acceptance notification message from the ROP server to the customer device via the second communication channel, but in response to not receiving at the ROP server an order acceptance message from the merchant terminal within the first threshold interval, sending an order failure message from the ROP server to the customer device via the second communication channel,
g. in response to receiving at the ROP server an order acceptance message from the merchant terminal within the first threshold interval, monitoring at the ROP server for confirmation within a second threshold interval from at least one of the merchant terminal and the customer device of order fulfillment at the location, and
h. in response to receiving at the ROP server confirmation within the second threshold interval of order fulfillment, closing the second communication channel, but in response to not receiving at the ROP server confirmation within the second threshold interval of order fulfillment, sending an order failure message from the ROP server to the customer device via the second communication channel.

According to another aspect of the present invention, there is provided a medium encoding instructions, which are readable and executable by a computing or communication device, for performing a method of connecting a merchant terminal to a remote ordering platform (ROP) server for communication therebetween, the ROP server having a load balancer and a plurality of distributed hosts, comprising:
a. sending from the merchant terminal a GetHostList message to the load balancer,
b. at the merchant terminal, receiving from the load balancer a PriorityListofHosts message that provides a plurality of uniform resource identifiers respectively associated with the plurality of distributed hosts, the plurality of uniform resource identifiers being prioritized such that higher priority uniform resource identifier are more likely than lower priority uniform resource identifiers to represent an efficient connection,
c. in order of priority, sending from the merchant terminal an authorization request to the one of the plurality of distributed hosts associated with a one of the plurality of uniform resource identifiers and waiting a first interval to receive an authentication acknowledgement, and
   i. if an authentication acknowledgement is received within the first interval, opening a connection with that one of the plurality of distributed hosts, but
   ii. if an authentication acknowledgement is not received within the first interval, repeating step c. with the next highest priority one of the plurality of uniform resource identifiers, but
   iii. if an authentication acknowledgement is not received within the first interval and there is not an untried one of the plurality of uniform resource identifiers, then repeating step a., and
d. if a connection with one of the plurality of distributed hosts has been opened, monitoring at the merchant terminal for a periodic KeepAlive message from the one of the plurality of distributed hosts and in response sending to the one of the plurality of distributed hosts an Okay acknowledgement to keep open the communication channel.

According to another aspect of the present invention, there is provided a medium encoding instructions, which are readable and executable by a computing or communication device, for performing a method of connecting a merchant terminal to a remote ordering platform (ROP) server for communication therebetween over a network, the ROP server having a load balancer and a plurality of distributed hosts, comprising:
a. receiving at the load balancer a GetHostList message from the merchant terminal,
b. sending from the load balancer to the merchant terminal a PriorityListofHosts message that provides a plurality of uniform resource identifiers respectively associated with the plurality of distributed hosts, the plurality of uniform resource identifiers being prioritized such that higher priority uniform resource identifier are more likely than lower priority uniform resource identifiers to represent an efficient connection,
c. in order of priority, receiving from the merchant terminal an authorization request at a one of the plurality of distributed hosts associated with a one of the plurality of uniform resource identifiers, sending an authentication acknowledgement to the merchant terminal, and opening a connection with the merchant terminal, and
d. sending from the one of the plurality of distributed hosts to the merchant terminal a periodic KeepAlive message and in response to receiving an Okay acknowledgement within a first interval keeping open the communication channel but in response to not receiving an Okay acknowledgement within the first interval closing the communication channel.

Further aspects and advantages of the present invention will become apparent upon considering the following drawings, description, and claims.

### DESCRIPTION

The invention will be more fully illustrated by the following detailed description of non-limiting specific embodiments in conjunction with the accompanying drawing figures. In the figures, similar elements and/or features may have the same reference label. Further, various elements of the same type may be distinguished by following the reference label with a second label that distinguishes among the similar elements. If only the first reference label is identified in a particular passage of the detailed description, then that passage describes any one of the similar elements having the same first reference label irrespective of the second reference label.

### 1. BRIEF DESCRIPTION OF THE DRAWINGS

FIG. 1 is a UML 2 use-case diagram of participants and their participation in a conventional e-commerce transaction, for example a transaction for a quick service restaurant meal.

FIG. 2 is a UML 2 deployment diagram of one embodiment of a computing and communication network configured in accordance with aspects of the present invention.

FIG. 3 is a deployment diagram of a general purpose programmable computing and communication device that is configurable in accordance with aspects of the present invention to be embodied in the network of FIG. 2.

FIG. 4 is a UML 2 deployment diagram of client nodes that are configurable in accordance with aspect of the present invention to be embodied in the network of FIG. 2, including Merchant Terminal and Customer clients.

FIG. 5 is a UML 2 deployment diagram of server nodes that are configurable in accordance with aspect of the present invention to be embodied in the network of FIG. 2, including Issuing Bank, Merchants' Bank, Gateway, Processor, Acquirer and Remote Ordering Platform (ROP) servers.

FIG. 6 is a UML 2 deployment diagram detailing one embodiment of the ROP server of FIG. 5, including Ordering Portal, Scheduler, Database Server and Host nodes.

FIG. 7 is a UML 2 deployment diagram detailing one embodiment of the Host node of FIG. 6, including API/Load Balancer and first, second and third Distributed Host nodes.

FIG. 8 is a UML 2 class diagram of one embodiment of a domain model for transaction communications over the network of FIG. 2.

FIG. 9 is a deployment diagram detailing embodiments of the connection between Merchant Terminals and ROP Hosts.

FIG. 10 is a UML 2 sequence diagram of one embodiment of a method of setting-up and maintaining a connection of a Merchant client of FIG. 4 to the network of FIG. 2.

FIG. 11 is a UML 2 sequence diagram of one embodiment of a method of setting-up and maintaining a connection of a Customer client of FIG. 4 to the network of FIG. 2.

FIG. 12 is a UML 2 activity diagram, from the perspective of the ROP, of a lifecycle of an Order transacted on the Network of FIG. 2.

### 2. DETAILED DESCRIPTION OF SPECIFIC EMBODIMENTS

### (a) Context

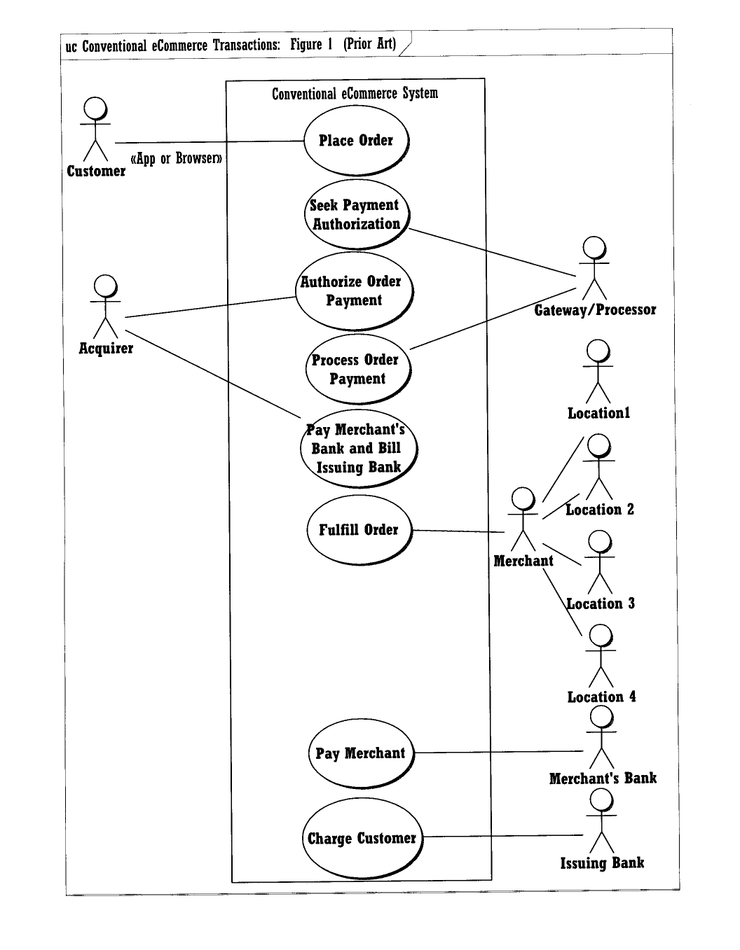

FIG. 1 shows a variety of exemplary participants and their participation in a conventional e-commerce transaction. As will be described further below, certain types of transactions, for example transactions for quick service restaurant meals, place significant technical demands on an underlying computing and communication network. In other words, unless the underlying computing and communication network addresses certain technical challenges, it will be difficult to successfully conduct the intended business over that network.

Some of the technical solutions taught by the present invention will be described through exemplary applications in the quick service restaurant sector; however, those skilled in the art will recognize that such technical solutions can be applied more broadly to deliver useful benefits in other sectors and applications.

### (i) General Transactions

In a conventional e-commerce transaction, a Customer places an order with a Merchant. In other words, the Customer uses a web browser or dedicated application on a computing and communication device to communicate with the Merchant over a computing and communication network.

Implicitly or explicitly, the Customer promises to pay for the order, either before, while or after the Merchant fulfills the order. In this regard, the Customer might provide recourse to a payment account, such as a debit account or a credit account.

If a payment account is provided for payment of the order, the Merchant's payment Processor may seek payment authorization from an Acquirer. In some cases, the Merchant may retain a Gateway to select between Processors, for example based upon the nature of the order and the nature of the payment account. Authorization may be sought upon interrogating a token associated with the payment account such as a payment card or fob, for example via a magnetic, chip-and-PIN or near-field interface. Alternatively, authorization may be sought upon interrogating only an alias of the account, for example an account number, an account-holder's name, a security code, and/or an expiration date. Authorization may include: assessing whether the payment account has sufficient capacity to pay for the order, assessing the likelihood that the account is being provided by its owner or lawful delegate as opposed to someone without lawful authority, for example by assessing whether the transaction is consistent with the account history, or assessing the riskiness of the transaction, for example the size of the transaction.

If the Acquirer grants authorization and the Merchant either has fulfilled the order or else requires prepayment for the order, then the Processor will process the order and the Acquirer will (a) charge the order to the Issuing Bank that issued the payment account to the Customer and (b) make payment for the order to the Merchant's Bank. The Merchant's Bank will credit the Merchant's account and the Issuing Bank will charge the Customer. Finally, the Customer will pay the charge to the Issuing Bank.

In some cases, the Merchant may have more than one Location for fulfilling orders, in some cases many more than one Location—for example Locations throughout a country or even further afield. In this regard, a Location may be a conventional bricks and mortar establishment, or else it may be a mobile establishment or even a virtual establishment. In such cases, a Customer may place the order with a central Merchant presence, for example a chain-wide website, for example maintained by a Franchisor, but may have the order fulfilled by one of the many Locations as chosen by either the Customer, the Merchant, or the Location.

### (ii) Demanding Transactions

As mentioned above, some types of ecommerce transactions, for example quick service restaurant transactions, have characteristics and constraints that present significant technical challenges that must be addressed by the underlying computing and communication network.

One fundamental characteristic of such transactions is that the time interval between order commencement and order fulfillment is short—communications tend to be urgent. During this interval, the parties need to be identified, and the order needs to be specified and fulfilled. The following kinds of decisions need to be made:
Which Location (or Locations with respect to multi-unit fulfilled orders, or distributed orders) will prepare or fulfill the order?
Will the Customer or a delegate receive the fulfilled order?
   Will identification be required to receive the fulfilled order, and if so what?
   Where will the Customer receive the fulfilled order (designated drop-off point, home/business delivery, curb-side, distributed delivery)?
   How will the Customer receive the fulfilled order (in-store pickup counter, curb-side, table delivery)?
How will the Customer pay for the order, given business rules required by the Merchant?
Does the Merchant offer the set of items (including product modifiers, options and related attributes) that the Customer wants to order?
   If so, can the order be fulfilled at the relevant Location(s)?
      If not, is a substitute order available for offer at the relevant Location?
      If not, can the order be fulfilled from an alternative Location having the requisite inventory or capabilities, for example a full-service Location as opposed to an express Location with a more limited
In the event of a Customer item request that cannot be fulfilled by the Merchant, for whatever reason, would the Customer accept an alternate or substitute product, product modifier, option or optional attribute?
Can the Merchant fulfill the specified order within the specified interval?
   If not, would the Customer accept a longer interval?
   If not, can the Merchant fulfill a substitute order, of for example simpler or already prepared items?
   If not, can the Merchant fulfill the order from an alternative
Location having inventory, capabilities or volume more suitable for fulfillment within the interval?
Can the Merchant recommend additions or modifications to the order that are necessary or desirable for Customer satisfaction?
Can the Merchant recommend additions or modifications to the order that would reduce perishable inventory at the relevant Location at a compelling price for the Customer?
Can the Customer rely that the relevant Location has received his order and is fulfilling it within the agreed interval?
   What kind of progress reports does the Customer want to receive, if any, during the preparation and fulfillment of the order.
   If problems or opportunities develop during fulfillment of a placed order, does the Customer want to accept the
How should resources at the Location be allocated to fulfilling this order in conjunction with other pending orders.
   If resources become insufficient to fulfill all pending orders, how should resources be rationed?
      Can orders be transferred to another Location?
      Can the selection of a particular order for fulfillment failure reduce consequences for the remaining pending orders?
      Can the selection of a particular Customer for fulfillment failure reduce consequences to customer relationships for the Merchant or Location?

Those skilled in the art will recognize that these questions and decisions correlate with various types and timing of notification that are addressed by the teaching herein below.

A number of observations can be made about the challenges posed by these kinds of transactions, challenges that call out for technical solutions. In such transactions, there are many decisions to explore, clarify, negotiate, act upon, report progress on, and perhaps renegotiate throughout the interval. The participants in this communication are typically at different, and sometimes changing, locations.

Success calls out for communications that have a number of characteristics, and for computing and communications networking technologies that can support such characteristics.

Duplex communication between the Customer, the Merchant and the Location(s), during the ordering process and through to fulfillment of the order, enable an ongoing dialog to explore, clarify, negotiate, report progress on and perhaps renegotiate the order.

Structured communication keeps the dialog focused on transactions for offered items that can be fulfilled from available inventory during an agreed interval. Structured communication captures necessary information for fulfilling orders and produces actionable orders that can be fulfilled to provide items with specified attributes and options at an agreed price. In contrast, open or freeform communication can be missed by a recipient, can have ambiguous implementation, or can be difficult to implement without further information or renegotiated terms such as a price adjustment thereby perhaps leading to unmet expectations or economic inefficiency.

Reliable communication allows participants to rely that others have timely received their communications unless the communication network has alerted them otherwise and that they can expect to receive timely communications from others unless the communication network has alerted them otherwise. In other words, participants' expectations of quality of service are demonstrably met.

Robust communication allows participants to expect that the communication network will be available when needed, to handle many-to-many ad hoc connections to both continuous participants (e.g. Merchant and Locations) and intermittent participants (e.g. Customers).

There will now be presented embodiments of computing and communication methods, systems, networks, nodes, devices and objects specially characterized and configured to provide the technical solutions to support this kind of communication in this kind of application and to satisfy the constraints imposed. Those skilled in the art will recognize that the nature of this kind of communication and this kind of application produces specific technical problems that require solution, as will be described further below.

### (b) Structure of Specific Embodiments

The structure of the invention will now be illustrated by explanation of specific, non-limiting, exemplary embodiments shown in the drawing figures and described in greater detail herein.

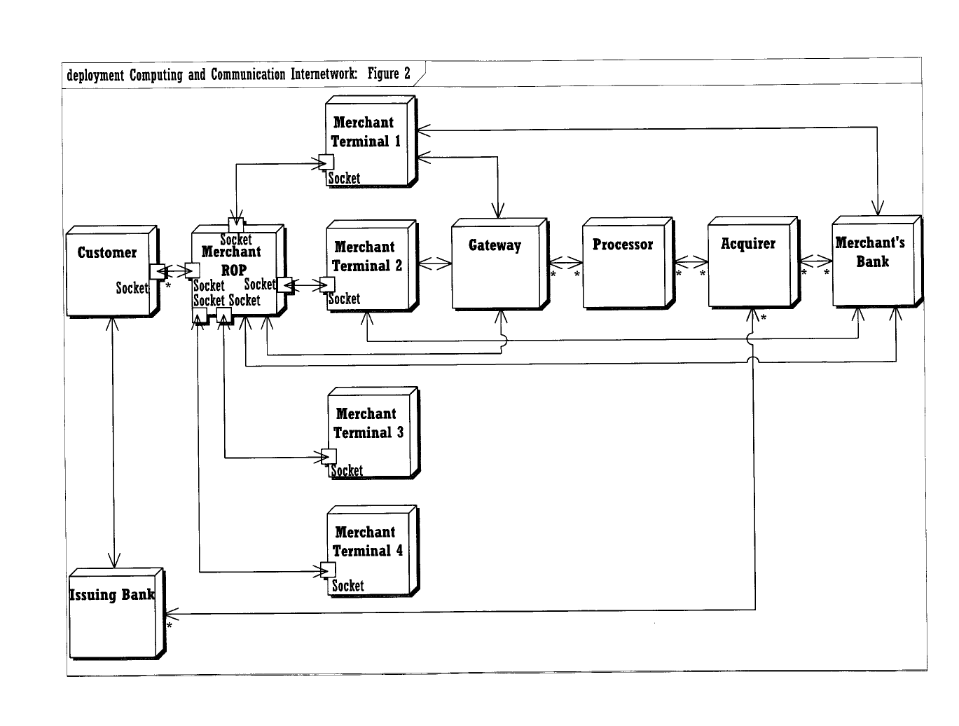

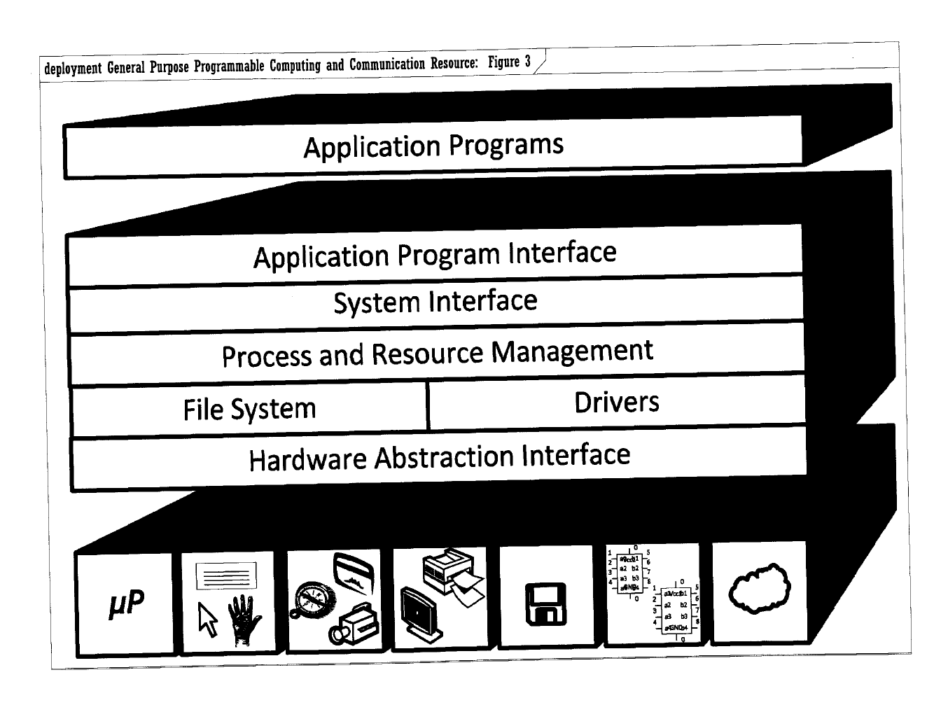

FIG. 2 shows a computing and communication internetwork (hereinafter “Network”) according to one embodiment of aspects of the present invention. This Network is the foundation of a computing and communication system (hereinafter “System”), for example an ecommerce system, for example a quick service restaurant system.

The Network connects together a number of nodes, some of which nodes may be categorized for convenience as Servers and some of which nodes may be categorized for convenience as Clients. The Server nodes might include a Merchant Remote Ordering Platform (hereinafter “ROP”), a Payment Gateway (hereinafter “Gateway”), a Payment Processor (hereinafter “Processor”), an Acquirer, a Merchant's Bank, and an Issuing Bank. The Client nodes might include many Customer nodes (only one Customer node being illustrated herein for clarity) and many Merchant Terminal nodes (illustrated herein as Terminal 1, Terminal 2, Terminal 3 and Terminal 4). In this regard, a Customer node might be a simple computing or communication device (for example a personal computer, a phone, or a tablet) that a Customer directly connects to the ROP for communication therewith, or it might be such a device in combination with and in communication with a third-party computing or communication resource whereby such device connects to the ROP server through the resource.

The participants of FIG. 1 participate in the System through appropriate nodes in the Network. For example, a Customer would participate through a Customer node, a Merchant through an ROP node, and a Location through a Terminal node. Those skilled in the art will recognize that each Location may in fact have more than one Terminal node.

Similarly, a Gateway would participate through a Gateway node, a Processor through a Processor node, an Acquirer through an Acquirer node, a Merchant's Bank through a Merchant's Bank node and an Issuing Bank through an Issuing Bank node.

Those skilled in the art will recognize that the network topology depicted in FIG. 2 has been simplified for clarity. For example, the network could be scaled to include multiple Servers for each node. Furthermore, a particular Server might be spread across multiple physical locations (or jurisdictions), which might increase, decrease or change over time, including on-the-fly, depending on resource demands and network management decisions. The Network could be provided as a managed network service.

Those skilled in the art will understand that in an internetworked system an action is often the result of coordinated activities occurring at multiple nodes in the system. In the case of a system built on the Internet, these nodes are often distributed ad hoc and unpredictably across multiple jurisdictions. The actions as described and claimed herein are intended to encompass at least: (a) actions performed directly and completely within the jurisdiction of the patent, (b) actions coordinated within the jurisdiction but with at least some activities performed outside the jurisdiction, (c) actions coordinated outside the jurisdiction but with at least some activities performed within the jurisdiction, and (d) actions performed for the benefit of a node within the jurisdiction or a person within the jurisdiction using that node. An example of such coordination would be serving a layout for a web page from one node and serving content for insertion into the layout from one or more other nodes, including through the use of server-side scripting, client-side scripting, and Asynchronous JavaScript and XML (AJAX) techniques.

In general, each of the Clients might be a duly configured general purpose programmable computing and communication resource, sometimes called a processing unit or a computing or communication device, for example a workstation, a desktop computer, a laptop computer, a tablet or a smartphone. Alternatively, a Client might be a more specific or purpose-built device, for example a wearable device, a media viewer, a home entertainment system, a gaming system, a smart appliance, a point-of-sale device, a payment authorization terminal such as a PIN pad, or a kiosk.

Each Server might similarly be a duly configured general purpose programmable computing and communication resource, including a farm of computing devices or one or more virtualized computers embodied as processes operating on a physical general purpose programmable computing and communication device. Such farmed or virtualized computers might themselves be distributed over their own local or wide area network, not shown.

In essence, the Servers and the Clients are roles or functions performed in the System by properly configured computing and communication resources. Multiple roles or functions could be performed by one device and one role or function could be distributed over multiple devices. The specific character and configuration of a device (and more generally the hardware) and the network topology is important to the extent that it supports the performance of the assigned roles or functions.

FIG. 3 shows an exemplary architecture for a typical computing and communication device embodying a node of FIG. 2. These devices have a bottom hardware layer, a middle operating system layer and a top application program layer. Those skilled in the art will recognize the aspects in which like virtualized hardware and devices depart from like physical ones.

The hardware layer provides the device with computing and communication hardware, including: (a) a processor to execute processes of instructions and to compute data, (b) user-input hardware to receive input from a user, such as a keyboard (real or virtual), a selection device (for example a mouse, touchpad, touchscreen or other haptic sensor), or a microphone, (c) environmental sensors to receive input from the environment, such as a camera, a location sensor (e.g. GPS global positioning satellite receiver or cellular radio), an orientation sensor (e.g. compass, gyroscope), a movement sensor (e.g. GPS, accelerometer), or a scanner (e.g. an optical scanner, a magnetic scanner, a chip-and-PIN scanner, a field scanner (e.g. radio frequency identification—RFID, near field communication—NFC), a chemical scanner, or a biometric scanner), (d) user-output hardware to provide information to a user, such as a video display, a printer or a speaker, (e) mass storage such as electromagnetic, optical or nonvolatile solid-state media to store data and processing instructions, (f) memory such as read only memory and random access memory to store data and processing instructions, and (g) a network interface to support communication with other devices in accordance with known protocols such as code division multiple access (CDMA), global system for mobile communications (GSM), long term evolution (LTE), IEEE standard 802.11 (VVi-Fi), IEEE standard 802.3 (Ethernet), and transmission control protocol/internet protocol (TCP/IP), all interconnected by buses such as address and data buses and control lines such as interrupt and clock lines and such other connections and components as is conventionally required and known in the art.

Stored in a portion of the read only memory and the mass storage are the components of the operating system layer, for example LINUX® or Microsoft® Windows® Server® or Mac® OS X Server® for a device such as general purpose programmable computer configured as a Server or LINUX® or Microsoft® Windows® or Mac® OS X° for a general purpose programmable computer configured as a Client or even Microsoft® Windows Phone®, Apple® iOS®, Google® Android®, BlackBerry® QNX® or Symbian®, for a portable such Client device. The operating system layer provides the basic instructions to direct the processor how to interact with the other hardware described above and more generally how to perform the functions of a communication and computing device, including storing, accessing and computing data, and communicating with other devices. The operating system may be configured or extended to provide a web services framework, such as for distributed computing, such as the Windows Communication Foundation application programming interface in the .NET Framework. Those skilled in the art will recognize that some of the functionality described herein can be well-implemented using advanced HTML standards with related caching and client-side logic. Much like HTML 5 now has standards to adhere to various screen resolutions and other controls, those skilled in the art will appreciate that future versions of HTML may have standardization around device accessibility for cameras, accelerometers, biometric receivers, compasses and other input, output and sensing components, and that future evolutions of HTML may have the ability for browser plug-ins or browser extended session support that provide similar services to current app notifications, even after a browser window might have been closed.

The operating system layer presents an application program interface to the application program layer, so the processor can execute more sophisticated combinations of processes under the direction of higher level application programs stored in mass storage and loaded into RAM for execution, for example the processes that will be elaborated below. This layer may also include more purpose-specific application programming interfaces, for example OLE for Retail POS (OPOS) or Java for Point of Sale Devices (JavaPOS) APIs for Point of Sale devices, as promulgated by the UnifiedPOS initiative.

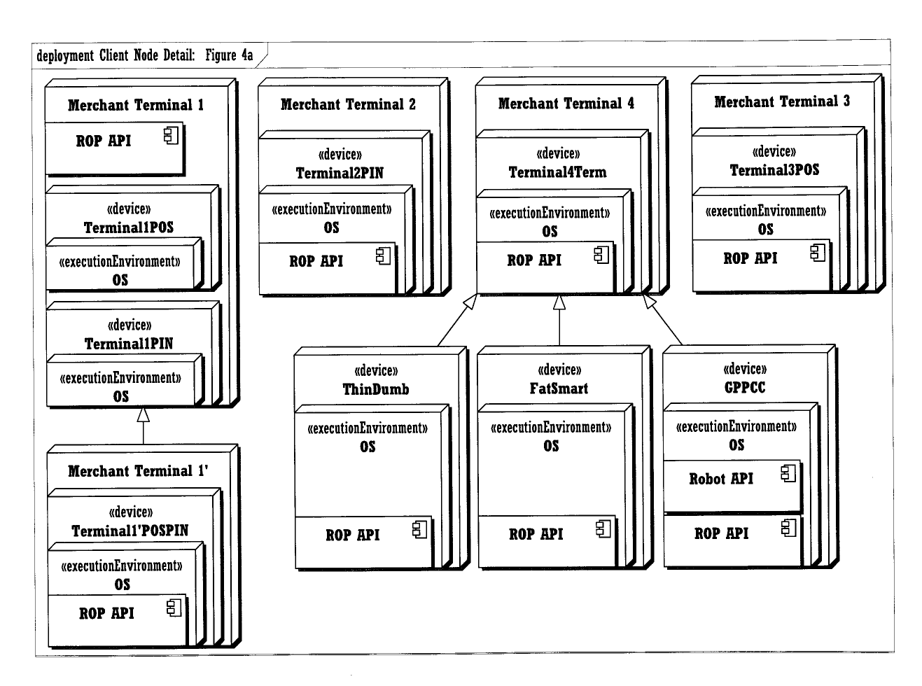

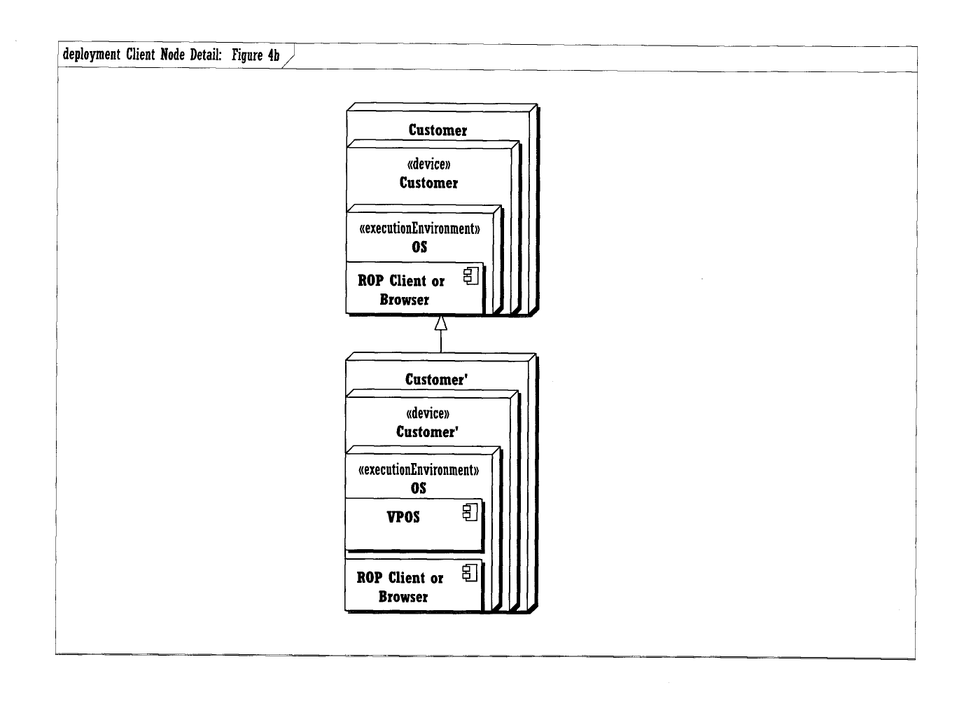

FIG. 4 shows a number of alternative exemplary embodiments of the Terminal nodes and the Customer node.

The Terminal 1 node includes a Point of Sale device (hereinafter “POS device”) in communication with an account authorization device (hereinafter “PIN device”) such as a PlNpad. The Terminal 1 node may have other computing and communication resources or devices as well. The Terminal 1 node is provisioned with an ROP client, for example implemented as a web service API (hereinafter “ROP API”) component, to communicate with the ROP Server. The ROP API may be provisioned on the POS device, the PIN device, or elsewhere on the Terminal 1 node, for example.

The Terminal 1′ node is similar to the Terminal 1 node; however, the POS and PIN functions are both provisioned on a single POSPIN device that also is provisioned with the ROP API component.

The Terminal 2 node is similar to the Terminal 1 node; however, the Terminal 2 node includes only a PIN device and not a POS device. The ROP API component may be provisioned on the PIN device. POS functionality may not exist, may be provisioned on an independent device, which may or may not be in communication with the Terminal 2 node, or may be provided by the ROP Server, for example through extended POS functionality in the ROP API.

The Terminal 3 node is similar to the Terminal 1 node; however, the Terminal 3 node includes only a POS device and not a PIN device. The ROP API component may be provisioned on the POS device. PIN functionality may not exist, may be provisioned on an independent device, which may or may not be in communication with the Terminal 3 node, or may be provided by the ROP Server, for example through extended PIN functionality in the ROP API.

The Terminal 4 node is similar to the Terminal 1 node; however, the Terminal 4 node does not include either a POS device or a PIN device—it is a standalone terminal. The Terminal 4 node may instead include a more general purpose terminal device on which the ROP API component may be provisioned. POS and PIN functionality may not exist, may be provisioned on an independent device, which may or may not be in communication with the Terminal 4 node, or may be provided by the ROP Server, for example through extended POS and PIN functionality in the ROP API.

In this regard, the Terminal 4 node may be implemented as a Thin/Dumb device, a more capable Fat/Smart device, or a more capable General Purpose Programmable Computing and Communication device (hereinafter “GPPCC device”).

In some embodiments, a Terminal node, for example a GPPCC device at the Terminal 4 node, may be provisioned with a Robot API component to direct processing equipment, for example a fountain drink dispenser, to activate in response to received structured order communications, as will be described in further detail below.

The Customer node includes a Customer device, for example of the kind described above for client nodes. The Customer device may be provisioned with either a dedicated ROP client application or a general web browser capable of rendering and interacting with web resources served by the ROP Server as will be described below.

In one embodiment, the Customer′ node may also be provisioned with a Virtual Point of Sale (hereinafter “VPOS”) component to interact with the ROP Server, for example through the dedicated ROP client application.

There are a number of benefits in deploying PIN devices, or more generally payment terminals, as Terminal nodes in the Network, for example as seen with Terminal 1 and Terminal 2. One of the benefits of payment terminals, and key to their proliferation in the industry, is their security. Because their main purpose is processing financial transactions, payment terminals are developed with a very high degree of security built into both their hardware and software design. This security provides all parties to a transaction confidence in the transaction. Consumers are assured their payment information will not be stolen or abused by a merchant. Merchants are assured that a customer's form of payment is authentic, and they have funds available which will be settled back to them. The financial system can be confident that both Merchants and Customers are not engaging in fraud, or other illegal activity. All participants are also assured of privacy and data integrity free from errors.

By using payment Terminals to receive customer transactions, Merchants can be assured of similar security. This security is far beyond what is available with any other merchant device, such as a personal computer, point of sale terminal, phone system, or fax system. In most cases all of the software loaded on a payment terminal is signed by a certifying entity, whether that is the merchant themselves or device manufacturer. This ensures that unauthorized software cannot be loaded onto these devices. Furthermore, most payment terminals have separate cryptographic processors providing an additional layer of security. By building upon the security of payment terminals, the System provides both Merchants and Customers with a high degree of security for their transactions. In this regard, System components installed on payment Terminals would be vetted and certified as described above, installed in their own “sandboxed” or virtualized execution environment, and allocated access priorities to resources that would be low enough not to interfere with core payment terminal operations, but high enough to meet their own performance metrics.

Along with security, integral to the success of payment terminals is their reliability. To ensure confidence in electronic payment transactions for both Customers and Merchants, payment terminals must be reliable in their operation, and deliver a very high level of uptime. As such, reliability is built into payment terminal design and deployment. This provides Merchants and Customers confidence that electronic payments will be available.

Reliability of payment terminals is built in through both their hardware and software design. Payment terminals usually employ multiple different types of connections, which may include: wired broadband data networks, wireless broadband data networks, wireless cellular data networks, and data over voice networks in the form of dial-up internet.

The reliability of payment terminals is a key benefit to using them for receiving Customer transactions. Merchants can be confident that transactions originating outside their premise will be reliability transmitted to them. This will minimize Customer transactions beings lost, and ensure Merchants can satisfactorily fulfill orders. Customers can be confident their transaction has been transmitted to the Merchant, and will be available as requested.

Another key benefit to sending Customer transactions to payment terminals is the existing large install base of payment terminals. Merchants and their Locations may vary greatly, but if payment terminal functionality hasn't been integrated into the point-of-sale terminal, a Merchant Location must have a payment terminal to accept electronic payment transactions. This necessity has led to a proliferation of payment terminals, and an almost ubiquitous install base in many areas, making payment terminals one of the most common devices deployed by Merchants. Applying aspects of the teachings of the present invention, Merchants can easily adopt and deploy an e-commerce System, as they already have the necessary hardware if they have a payment Terminal.

This large install base is installed and maintained by a dedicated sales force of Acquirers who are responsible to the Processors and Gateways for the integrity of their part of transactions. Therefore, the Acquirers and their sales force take care to authenticate the Merchants and Locations installing and using their payment terminals, and in many cases this authentication is redundant by way of supporting accounts with Processors and related Gateways. This added level of authentication provides further security to Customers and other participants.

Along with the large install base is the standardization of payment terminals. A limited number of vendors are authorized by the financial system to develop and sell payment terminals which connect to the financial institutions. This has caused a concentration of payment terminal vendors into a small number of firms. To support the key features of security and reliability, these vendors have kept their devices simple and standardized, so that Customers and Merchants can easily adopt and use them. This standardization is also helpful for deploying Systems in accordance with some of the teachings of the present invention. A merchant with multiple Locations will likely have very similar if not identical payment Terminals at every location. By transmitting Customer transactions from an e-commerce System to the merchant payment Terminals, the Merchant can more easily enable e-commerce Customer ordering, and deploy it to all of its Locations with a high degree of confidence the deployment and operation will succeed. This approach will also avoid many additional costs in upgrading existing hardware, as may be the case in the deployment of other e-commerce systems using point of sale Terminals or other computer systems. In fact, payment terminals with such functionality set dormant might be distributed as a matter of course by the sales force, such that capabilities as taught herein might be simply activated when a Merchant so desires.

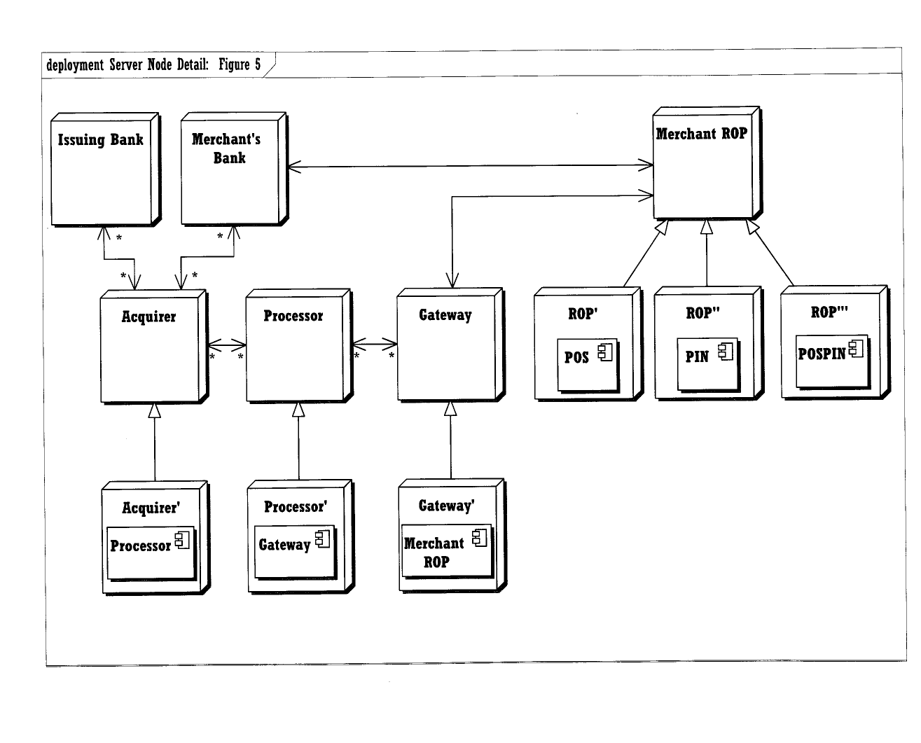

FIG. 5 shows a number of alternative exemplary embodiments of the ROP, Gateway, Processor and Acquirer nodes.

As described above with respect to FIG. 4, the ROP Server may be provisioned with not only its core remote ordering platform functionality (as will be described further below), but also with extended POS functionality (ROP′), PIN functional (ROP″), and POS and PIN functionality (ROP′″) to support Terminal Clients that lack such extended functionality.

In some embodiments, the ROP Server may be hosted by the Merchant, or may be hosted as a service by a third-party hosting service, for example. Other embodiments would include hosting the ROP Server on a Gateway′ Server, a Processor′ Server (that might subsume the Gateway Server functionality as well), or an Acquirer′ Server (that might subsume the Processor Server functionality as well). Those skilled in the art will recognize that downstream ROP-hosting on a Gateway′ Server, a Processor′ Server or an Acquirer′ Server could be advantageous when a sales force has deployed Merchants payment Terminals having dormant functionality in accordance with some of the teachings of the present invention, which functionality can be remotely activated without disruptive hardware or software installations or upgrades. Similarly, a Gateway′ Server, a Processor′ Server or an Acquirer′ Server would be able to download to payment Terminals components or upgraded components having such functionality, should a Merchant desire that they manage a ROP on its behalf.

By extension, those skilled in the art will recognize that Banks, whether at the Merchant's Bank node or the Issuing Bank node or through purchase or other capture of a Gateway, Processor or Acquirer could similarly provide such services and capabilities to Merchants with this System.

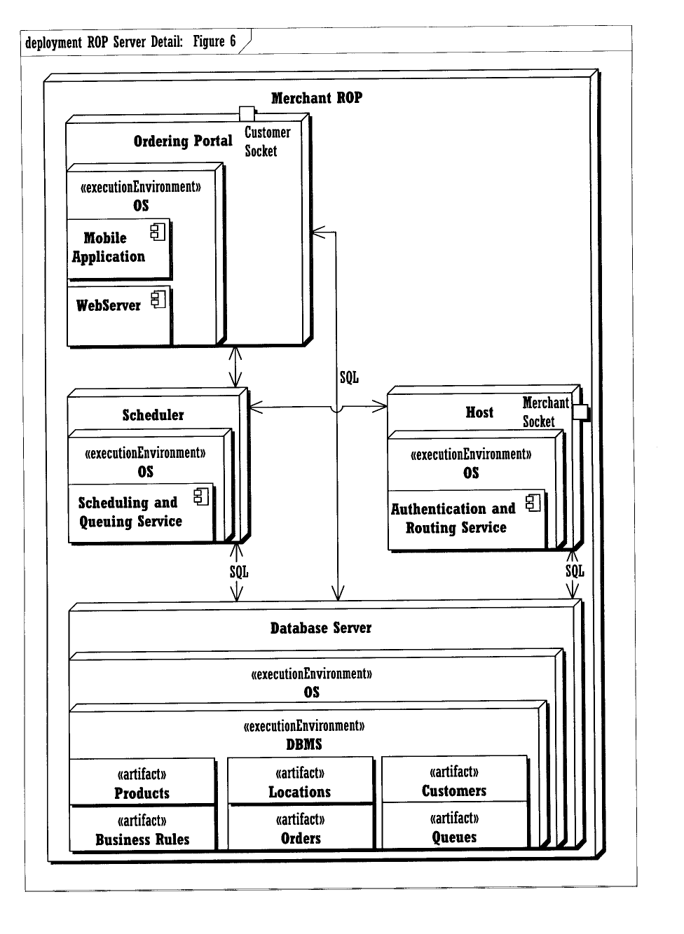

FIG. 6 shows an exemplary ROP Server in greater detail, including a Database Server node, an Ordering Portal node, a Scheduler node, and a Host node.

The Database Server node is provisioned with a Database Management System operating environment for managing database artifacts relating to Product Data (including more generally items and services), Location Data, Customer Data, Business Rules Data, Orders Data, and Queues Data. Although this resource is named and described as a database for convenient illustration, those skilled in the art will recognize that other implementations could be used to provide the same function and such are contemplated within the scope of the present teaching, for example a key-value or persistent object store, and such other implementations are intended to be included within the broader meaning of the word database, to include any sustaining record storage, whether state-driven, transactional or otherwise.

The Ordering Portal node may be provisioned with a dedicated Mobile Application hosting component and a more general WebServer component, through either of which a Customer may interact with the ROP (a) to obtain the information necessary to place an order, (b) to place the order, (c) to receive progress reports on the fulfillment of the order, (d) to renegotiate the order, and (e) to confirm fulfillment of the order. In this regard, the Ordering Portal node is in communication with the Database Server node as will be discussed in greater detail below.

The Scheduler node is provisioned with a Scheduling and Queuing Service component to direct orders to appropriate Locations at appropriate times for efficient and reliable fulfillment. In this regard, the Scheduling node is in communication with the Database Server node as will be discussed in greater detail below.

The Host node is provisioned with an Authentication and Routing Service component to accept and maintain connections from authenticated Terminal nodes and to route communications between such Terminal nodes, the ROP Server and Customer nodes involved in respective orders, as will be described further below.

With reference briefly to both FIGS. 2 and 6, one can observe socket connections established and maintained between the ROP Server and respective Merchant Terminals and more particularly between the ROP Server Host and respective Merchant Terminals, under the control of the ROP Server Host. Those skilled in the art will recognize that similar socket connections are established, maintained and destroyed between the ROP Server and respective Customer nodes, and more particularly between the ROP Server Ordering Portal and respective Customer nodes, under the control of the ROP Server Ordering Portal.

As will be described further below, deploying socket connections in combination with the Routing aspect of the Authentication and Routing Service, for example on a managed network, in accordance with the teachings herein provides a number of benefits, including:
having reliable communication paths already established when needed,
being able to detect and heal broken communication paths and to detect quickly network instabilities and outages in need of attention,
being able to reroute communications to a new Host should a previously connected Host node fail, and
being able to detect quickly when a Customer device or Merchant Terminal or Merchant Location is no longer participating in communications.

As will be described further below, deploying socket connections in combination with the Authentication aspect of the Authentication and Routing Service, for example on a managed network, in accordance with the teachings herein provides a number of benefits as well, including:
being able to detect quickly when a rogue terminal (or a wiped and reprogrammed terminal) has been substituted for a previously authorized terminal, for example by card-skimming fraud artists, and reject its connection and issue suitable alerts,
being able to identify a Customer or his delegate who arrives to receive an Order, by interrogating his previously authenticated mobile Customer device, for example by reading, scanning or more generally sensing (with or without the Customer's active participation) an identifier associated with the Customer or Customer device, for example a pick-up code transmitted to the Customer device after the Order has been placed, a Wi-Fi beacon, exchanged GPS coordinates, or a biometric identifier even as simple as a photograph, or
being able to identify a Customer or his delegate who arrives to receive an Order and confirm Order fulfillment, by presenting to a sensor on his previously authenticated mobile Customer device, an identifier associated with the fulfilled Order, for example a barcode or RFID tag or NFC tag and monitoring for an acknowledgement.

Identification and authentication arrangements are particularly useful when, for example, both the Merchant Location and the Customer are mobile and seeking to converge at a common physical location.

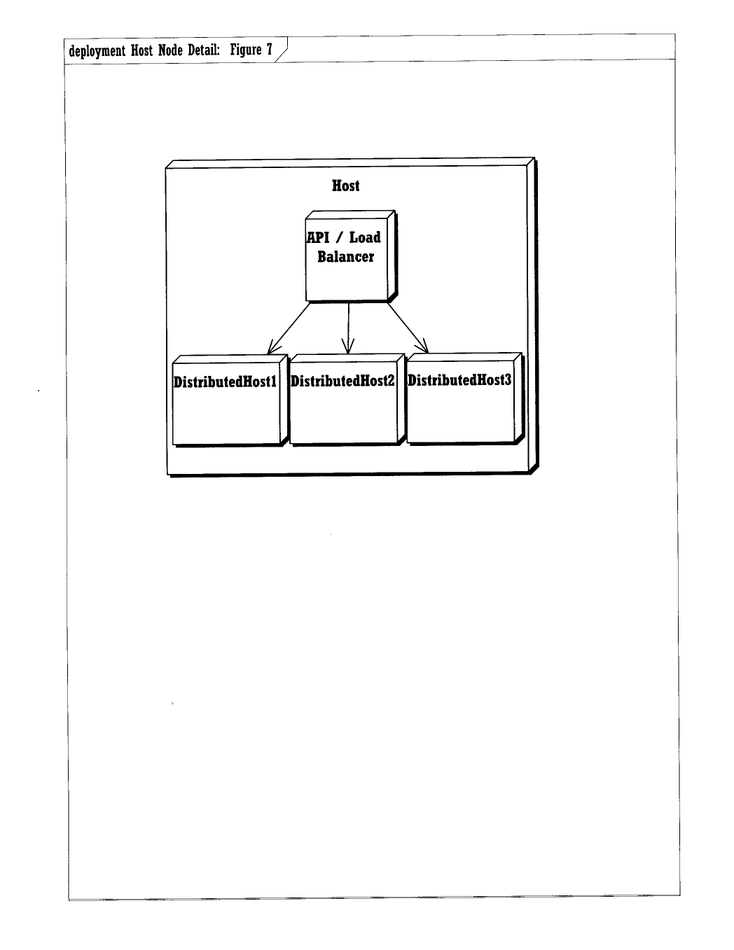

FIG. 7 shows an exemplary Host node in greater detail, including an API/Load Balancer node, and first, second and third Distributed Host nodes (DistributedHost1, DistributedHost2, DistributedHost3). The API/Load Balancer node is provisioned to assess the network load on each of the Distributed Hosts and to allocate load (traffic and connections) in pursuit of operation goals for stability and speed, for example.

The structure of software aspects of the System will now be described using an object-oriented paradigm. Those skilled in the art will recognize that there are many programming paradigms and analogous Systems can be programmed in accordance with such paradigms without departing from the spirit of the present invention. For example, other programming paradigms include: Agent-oriented, Automata-based, Component-based (including Flow-based and Pipelined), Concatenative, Concurrent computing (including Relativistic programming), Data-driven, Declarative (including Constraint, Functional, Dataflow (including Cell-oriented and Reactive) and Logic (including Abductive logic, Answer set, Constraint logic, Functional logic, Inductive logic, and Uncertain inference (including Markov logic and Probabilistic logic))), Event-driven (including Service-oriented and Time-driven), Expression-oriented, Feature-oriented, Function-level, Generic, Imperative (including Procedural), Language-oriented (including Discipline-specific, Domain-specific, Grammar-oriented (including Dialecting) and Intentional), Metaprogramming (including Automatic, Reflective (including Attribute-oriented) and Template (including Policy-based)), Non-structured (including Array and Iterative), Nondeterministic, Parallel computing (including Process-oriented), Programming in the large/small, Semantic, non-object oriented Structured programming paradigms (including Modular and Recursive) and Value-level.

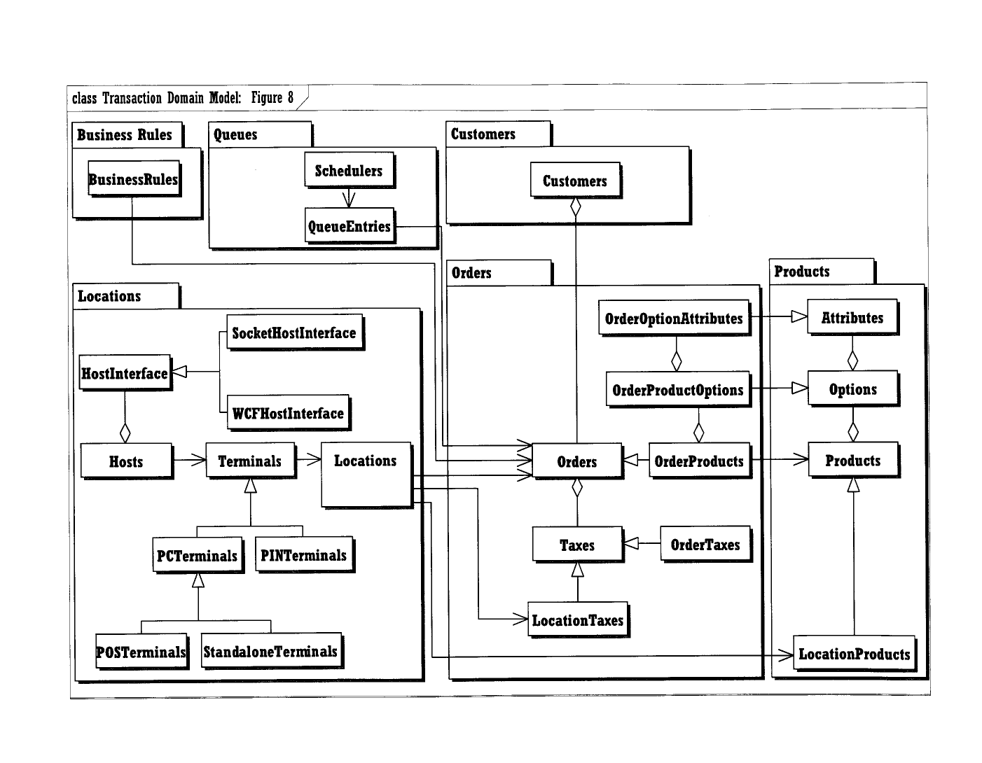

FIG. 8 shows an exemplary Domain Model for order transactions hosted on the System and more specifically on the ROP. The Domain Model includes packages that correspond to the database artifacts managed by the Database Server node, namely a ProductsPackage, a LocationsPackage, a CustomersPackage, a BusinessRules Package, an Orders Package, and a Queues Package.

The Products Package includes a Products Class, which is an aggregation of an Options Class, which is an aggregation of an Attributes Class. The Products class is also a generalization of a Location Products Class.

The Locations Package includes a Locations Class, which is associated with a Terminals Class, which is associated with a Hosts Class. The Terminals Class is a generalization of both a PINTerminals Class and a PCTerminals Class, which is in turn a generalization of both a POSTerminals Class and a StandaloneTerminals Class. The Hosts Class is an aggregation of a HostInterface Class, which is a generalization of both a SocketHostInterface Class and a WCFHostInterface Class.

The Customer Package includes a Customers Class.

The Business Rules Package includes a Business Rules Class.

The Orders Package includes an Orders Class, which is an aggregation of a Taxes Class, which is a generalization of both an OrdersTaxes Class and a LocationsTaxes Class. The Orders Class is also a generalization of an OrdersProducts Class, which is an aggregation of an OrdersProductsOptions Class, which is an aggregation of an OrdersOptionsAttributes Class.

The Queues Package includes a QueuesEntries Class, which is associated with a Schedulers Class.

Between packages, one will note that the Attributes Class is a generalization of the OrderOptionsAttributes Class, that the Options Class is a generalization of the OrderProductsOptions Class, and that the Products Class is associated with the OrderProducts Class.

The LocationsProducts Class and the LocationsTaxes Class are each associated with the LocationsClass.

The Orders Class is associated with each of the Locations Class, the BusinessRules Class, and the QueueEntries Class.

The Customers Class is an aggregation of the Orders Class.

Attributes and operations of the classes will now be further described.

The Hosts Class is responsible for authentication, routing and connection maintenance. All connections may be authenticated at the time of establishment. The Secure Socket Layer (SSL) and Transport Layer Security (TLS) protocols, or equivalents, can be used to provide protection against replay and impersonation attacks.

Connections can be maintained through the use of a heartbeat mechanism. Receive timeouts may be set to 90 seconds for both Terminal objects and Host objects, for example. In this example, each Host object would attempt to send a heartbeat to all connected Terminals objects once every 30 seconds, to which each of the Terminal objects should respond. This arrangement would allow for determination that a Terminal object (and its corresponding Terminal node) is online, accurate to within 90 seconds. Those skilled in the art will appreciate that other thresholds and other approaches would also work.

The Hosts Class is also responsible for translating communications to match the format understood by each respective Terminal device.

The functionality of the Hosts Class is further implemented through the HostInterface Class, the WCFHostInterface Class and the SocketHostInterface Class.

The HostInterface Class exposes a specific interface to support a subset of Terminal Client types as defined by the technologies supported by each Operating System. Each interface may be exposed on a different TCP port to allow a Host object to determine which connection-level translation layer to use for each Terminal Client connection. In this regard, for example, the WCFHostInterface Class exposes an interface suitable for use by Windows-based Terminals and the SocketHostInterface Class exposes an interface suitable for use by non-Windows based Terminals.

The Terminals Class is responsible for presentation of Order data, including notifications and other relevant communications at respective Locations and for interactions with users at those Locations.

The Terminals Class is also responsible for initial connection establishment with a ROP Host node and reconnection in case of connection loss.

The Terminals Class also tracks the online/offline status and type of respective Terminal devices at a Location.

The Terminals Class is responsible for providing Order data to associated POS devices in an agreed upon format.

The functionality of the Terminals Class is further implemented through the PINTerminals Class, the PCTerminals Class, the POSTerminals Class and the StandaloneTerminals Class.

In this regard, the PCTerminals Class for example, would represent the subset of Terminals supported on a general purpose platform, for example a PC platform. In contrast, the PinpadTerminals Class would represent a special purpose PlNpad Terminal with more limited programming and interface capabilities. In the case of the PCTerminals Class, the StandaloneTerminals Class would represent a fully featured Terminal Client capable of presenting its own UI and communicating with connected devices, for example printers, while the POSTerminals Class would represent an addon-type Terminal Client meant to be used in conjunction with existing POS software present on a computing device. Those skilled in the art will recognize that other classes might be deployed for other kinds of nodes or for nodes having different characteristics or configurations.

The Locations Class is responsible for handling Location (e.g. store) level authentication and information related to that Location, for example physical location and ownership.

The BusinessRules Class is responsible for validating Order data.

The Schedulers Class is responsible for monitoring and acting on orders based on various BusinessRules triggers. For example, an Order might expire after five minutes if it has not been accepted by a Location. As another example, a notification might be sent to a Location five minutes prior to the scheduled pickup time for an Order.

The Customers Class is responsible for creating, reading, updating, deleting and authenticating Customer-specific data for logged-in Customers; however, in some embodiments Orders may also be placed by anonymous guest Customers.

The Orders Class is responsible for aggregating information comprising an order, for example Products, Taxes, and Location.

The QueueEntries Class represents the status of a given Order and information necessary to facilitate scheduling and triggering of state changes, for example the current Scheduler assigned and an expiration time.

The Taxes Class is a general representation of common tax information.

The LocationTaxes Class represents specific taxes and fees that are implemented at a Location (e.g. store) level, for example delivery fees, bottle deposits, and state/county sales taxes.

The OrderTaxes Class represents taxes and fees applied to a respective Order.

The Products Class represents information about items (e.g. products and services) offered for Order.

The LocationProducts Class represents items that can be ordered from a specific Location, reflecting local merchandising or inventory constraints.

The OrderProducts Class represents items included in a respective order.

The Options Class represents options that can be set or added to a given Product, for example ketchup or ice cream.

The OrderProductOptions Class represents options set for a respective Product that is associated with a respective Order.

The Attributes Class represents modifiers for options that can be applied to Products, for example five packages of ketchup or chocolate ice cream.

The OrderOptionAttributes Class represents modifiers set for a respective Option, applied to a respective Product, in a respective Order.

Those skilled in the art will recognize the opportunity to present promotions in an event-driven manner, as ready-built combinations, or as limited-time or one-to-one offers/coupons/discounts, using much the same object architecture as for taxes described above, so as to be calculated in real-time, on checking or updating a shopping cart, for example. For example, taxes may be conditional, based on the contents of a cart (eg a bakery item is taxable unless purchased in a quantity greater than or equal to six) or based on a customer classification (eg milk is not taxable with purchase of meal if the customer is a child or milk is determined by the Location to be provided for consumption by the child).

Much like taxes, discounts/offers/coupons are often event-driven, based on what products/modifiers/options are included in a customer's cart. In some cases, a cart may be pre-populated by an offer, for example, upon a customer responding to a marketing text offering a 50% discount on a purchase of coffee within the next two hours. Should the customer respond to the offer, for example via a web or app interface, a 50% coupon would appear in their cart and the customer might be prompted to select a qualifying store, within the permitted time threshold to redeem the offer. Such object architecture could support iteration of promotions/coupons/offers/discounts at a faster pace and be subject to more real-time dynamic updates of the shopping cart than one would typically encounter for taxes. In this regard, one might implement an Offers Class, and OrderOffers Class and a LocationOffers Class (not illustrated for simplicity, but analogous to similarly named Taxes classes, as described above).

This Domain Model provides benefits directed to not only effective Order execution, but also to maintaining data useful for troubleshooting and growing both the underlying Network and also the System and more generally the business. For example, when data indicates that a Location is underperforming, further interrogation of Hosts and Terminals objects in the Locations Package might show whether Network technical problems limited transaction communications with that Location, while further interrogation of the QueuesEntries objects in the Queues Package might show that management was having Order execution problems, and while wider ranging interrogation of the Domain Model might suggest that the mix or pricing of Products offered at the problem Location were incorrect compared to comparable Locations. In other words, this fusion of the technical and business domains enables correlating business and technical metrics for a portion of the network over a period of time.

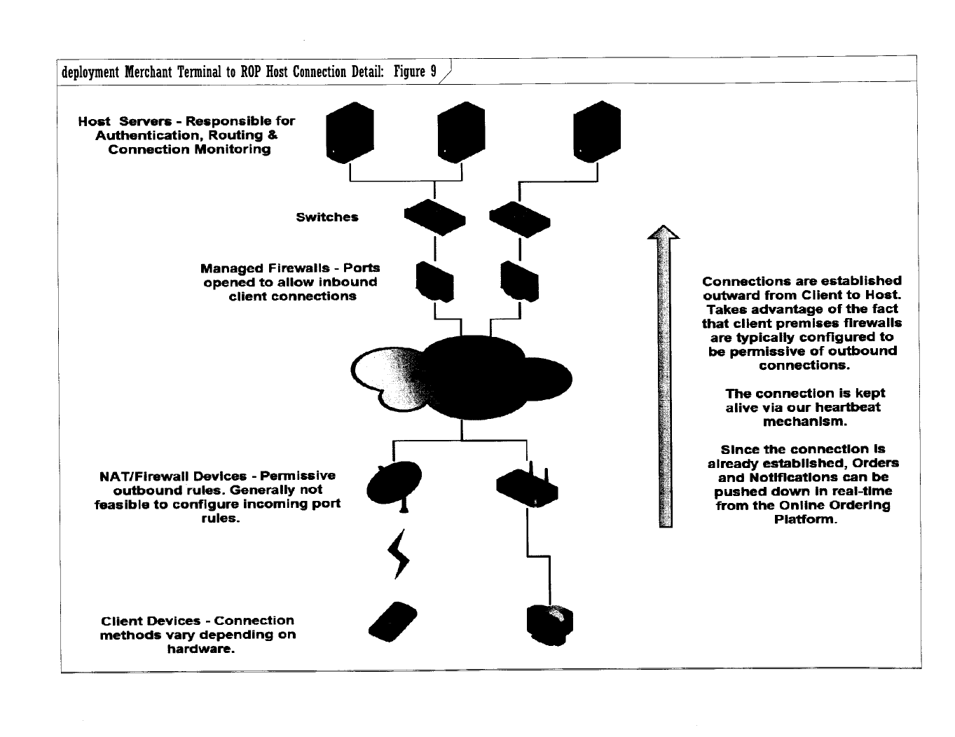

FIG. 9 shows exemplary embodiments of the connection between Merchant Terminals and ROP Hosts, with their respective firewalls demarcating the public Internet between them. Those skilled in the art will recognize similarities to the connection between the Customer Clients and the ROP Ordering Portal.

Firewall configurations on the many (Merchant Terminal) and many (Customer Client) ends of the Network are difficult to predict and configure, other than to predict that establishing inbound connections will be difficult. On the other hand, such firewalls are generally more permissive regarding outbound connections. Furthermore, the firewall configuration for the Hosts is much more knowable and controllable by the operator of the ROP. Therefore, ROP firewall ports can be configured open to allow inbound requests for connections to be created and maintained, so that such connections are then available for use as needed without additional setup.

### (c) Operation of Specific Embodiments

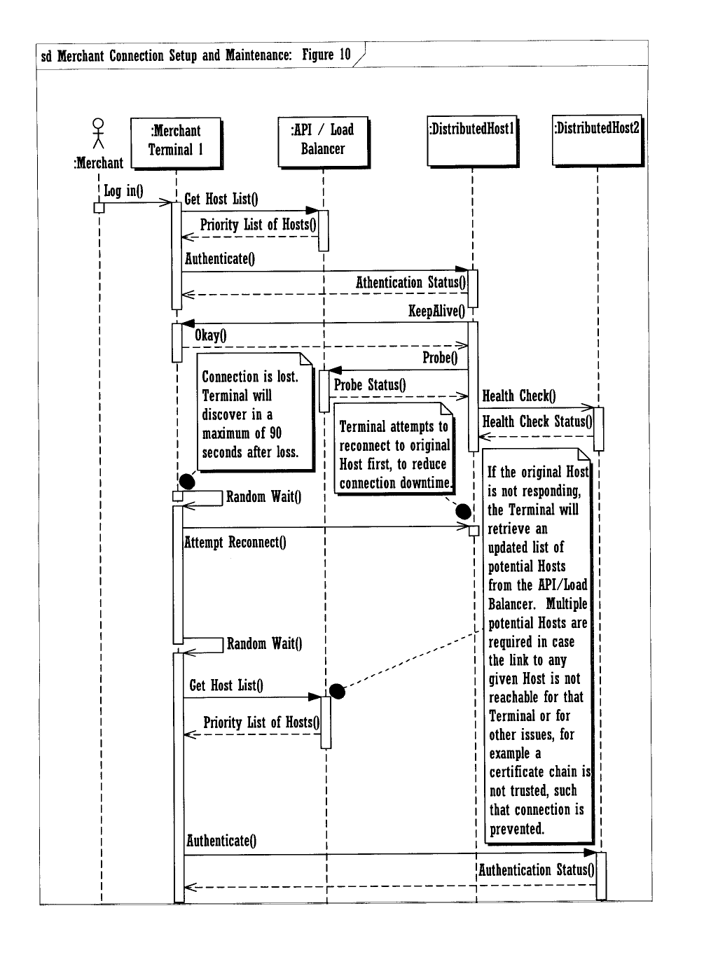

With reference now to FIGS. 10 to 12, the operation of these specific embodiments will now be described. FIG. 10 shows an exemplary sequence of steps for connecting a Merchant Terminal to a Host and maintaining and establishing the connection.

A Merchant user at a Location logs into a Merchant Terminal. The Merchant Terminal requests from the API/Load Balancer a priority list of Distributed Hosts available for connection and the API/Load Balancer returns the priority list.

The Terminal requests authentication from the Distributed Host having the highest priority on the list and the Host confirms authentication and a socket connection is established.

At regular intervals, the Distributed Host sends a KeepAlive message to the Terminal to maintain the connection and the Terminal returns an acknowledgement to maintain the connection. Those skilled in the art will recognize that the direction of this communication could be reversed, such that at regular intervals, the Terminal sends a KeepAlive message to the Distributed Host to maintain the connection and the Distributed Host returns an acknowledgement to maintain the connection.

At regular intervals, the Distributed Host may send a Probe message to the API/Load Balancer to receive back a ProbeStatus acknowledgement to verify that connection.

At regular intervals, the Distributed Host may send a HealthCheck message to respective other Distributed Hosts and receive back a HealthCheck acknowledgement to verify those respective connections.

If the connection between the Distributed Host and a Terminal is lost, the Terminal will detect that loss within the regular keep alive interval, for example 90 seconds, and will attempt reconnection. If that reconnection attempt is unsuccessful, for example because the Distributed Host or its connection path have failed, then the Terminal will again request from the API/Load Balancer a priority list of Distributed Hosts available for connection and the API/Load Balancer will return the priority list. The Terminal will then request authentication from a new Distributed Host having the highest priority on the list, and which is also not the lost Distributed Host, and that new Distributed Host will confirm authentication and a socket connection will be established.

Those skilled in the art will appreciate that health and other connection status information can be maintained and monitored at the API/Load balancer in the ROP for troubleshooting, planning and other purposes.

Those skilled in the art will recognize that FIG. 10 and its description in particular, and the specification as a whole more generally, teach and illustrate a way of connecting a merchant terminal to a remote ordering platform (ROP) server for communication therebetween, the ROP server having a load balancer and a plurality of distributed hosts, by:
a. sending from the merchant terminal a GetHostList message to the load balancer,
b. at the merchant terminal, receiving from the load balancer a PriorityListofHosts message that provides a plurality of uniform resource identifiers respectively associated with the plurality of distributed hosts, the plurality of uniform resource identifiers being prioritized such that higher priority uniform resource identifier are more likely than lower priority uniform resource identifiers to represent an efficient connection,
c. in order of priority, sending from the merchant terminal an authorization request to the one of the plurality of distributed hosts associated with a one of the plurality of uniform resource identifiers and waiting a first interval to receive an authentication acknowledgement, and
   i. if an authentication acknowledgement is received within the first interval, opening a connection with that one of the plurality of distributed hosts, but
   ii. if an authentication acknowledgement is not received within the first interval, repeating step c. with the next highest priority one of the plurality of uniform resource identifiers, but
   iii. if an authentication acknowledgement is not received within the first interval and there is not an untried one of the plurality of uniform resource identifiers, then repeating the sending step a, and
d. if a connection with one of the plurality of distributed hosts has been opened, monitoring at the merchant terminal for a periodic KeepAlive message from the one of the plurality of distributed hosts and in response sending to the one of the plurality of distributed hosts an Okay acknowledgement to keep open the communication channel,
e. wherein monitoring at the merchant terminal for a periodic KeepAlive message from the one of the plurality of distributed hosts may include monitoring for a second interval and in response to not receiving a periodic KeepAlive message from the one of the plurality of distributed hosts within the second interval, sending from the merchant terminal an authorization request to the one of the plurality of distributed hosts and waiting a third interval to receive an authentication acknowledgement,
f. wherein waiting a third interval to receive an authentication acknowledgement may include, in response to not receive an authentication acknowledgement within the third interval, sending from the merchant terminal a GetHostList message to the load balancer,
g. wherein in response to not receive an authentication acknowledgement within the third interval, optionally sending from the merchant terminal a GetHostList message to the load balancer, includes receiving from the load balancer a PriorityListofHosts message that provides a plurality of uniform resource identifiers respectively associated with the plurality of distributed hosts and ignoring the one of the plurality of uniform resource identifiers associated with the one of the plurality of distributed hosts,
h. wherein opening the connection may includes sending to the one of the plurality of distributed hosts information about the merchant terminal as required to configure connection-level translation at the one of the plurality of distributed hosts,
i. wherein opening the connection may include opening a managed connection, and
j. wherein opening the connection may include connecting sockets.

Those skilled in the art will also recognize that FIG. 10 and its description in particular, and the specification as a whole more generally, teach and illustrate a way of connecting a merchant terminal to a remote ordering platform (ROP) server for communication therebetween over a network, the ROP server having a load balancer and a plurality of distributed hosts, by:
receiving at the load balancer a GetHostList message from the merchant terminal,
sending from the load balancer to the merchant terminal a PriorityListofHosts message that provides a plurality of uniform resource identifiers respectively associated with the plurality of distributed hosts, the plurality of uniform resource identifiers being prioritized such that higher priority uniform resource identifier are more likely than lower priority uniform resource identifiers to represent an efficient connection,
in order of priority, receiving from the merchant terminal an authorization request at a one of the plurality of distributed hosts associated with a one of the plurality of uniform resource identifiers, sending an authentication acknowledgement to the merchant terminal, and opening a connection with the merchant terminal, and
sending from the one of the plurality of distributed hosts to the merchant terminal a periodic KeepAlive message and in response to receiving an Okay acknowledgement within a first interval keeping open the communication channel but in response to not receiving an Okay acknowledgement within the first interval closing the communication channel,
optionally further including periodically sending from at least one of the load balancer and one of the plurality of distributed hosts a Probe message and monitoring for receipt within a second interval of a ProbeStatus acknowledgement,
optionally, in response to not receiving within the second interval a ProbeStatus acknowledgement, closing any open communication channel between the one of the plurality of distributed hosts and any merchant terminal and removing from the PriorityListofHosts any uniform resource identifier associated with the one of the plurality of distributed hosts,
optionally further including periodically sending from the one of the plurality of distributed hosts to each of the other of the plurality of distributed hosts a respective HealthCheck message and monitoring for receipt within a third interval of a respective HealthCheckStatus acknowledgement,
optionally, in response to not receiving within the third interval a HealthCheckStatus acknowledgement from an other one of the plurality of distributed hosts, closing any open communication channel between the other one of the plurality of distributed hosts and any merchant terminal and removing from the PriorityListofHosts any uniform resource identifier associated with the other one of the plurality of distributed hosts,
wherein opening the connection includes selecting connection-level translation appropriate for the merchant terminal,
wherein opening the connection includes opening a managed connection,
wherein opening the connection includes connecting sockets, and
optionally further including correlating business and technical metrics for a portion of the network over a period of time.

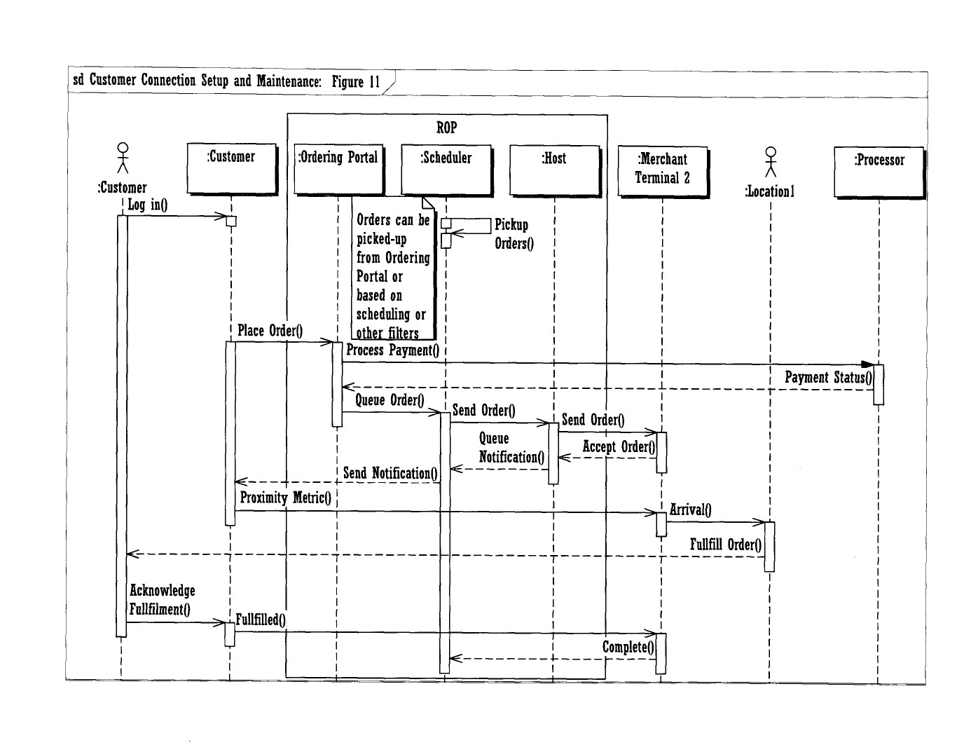

FIG. 11 shows an exemplary sequence of steps for connecting a Customer device to the ROP Server and Merchant Terminal.

A Customer logs into his Customer Device and places an Order at the Ordering Portal node. Payment for the order is processed by a Processor node and Payment Status confirmation is received back at the Ordering Portal node.

The Ordering Portal sends a Queue Order message to the Scheduler node which in turn sends a Send Order message to a Host node, which in turn sends a Send Order message to a Merchant Terminal at the Location selected for fulfilling the Order.

The Merchant Terminal sends an Accept Message order back to the Host, which in turn sends a Queue Notification message back to the Scheduler node, which in turn sends a Send Notification message back to the Customer device to confirm that the Order has been successfully placed with the Location chosen for fulfillment.

More generally, the Host node may initially broadcast Send Order messages to many or all Merchant Terminals at the Location, such that a first available one of the Merchant Terminals accepts the Order with an Accept Message. Alternatively, the Host node may send particular Send Order messages to particular Merchant Terminals at the Location, for example Orders for delivery to a first one of the Merchant Terminals and orders for pickup to a second one of the Merchant Terminals.

Through this same communication pathway, the Customer device may send proximity updates to the Terminal (and the Scheduler) to improve predictions about when the Customer may arrive at the Location and in this regard the Terminal may alert the Merchant user to the Customer's arrival at the Location, for example by transmitting GPS or cellular coordinates of the Customer device. Once a Customer device is sufficiently proximate to the Location, for example within range of a wireless (for example Wi-Fi) network hosted at the Location, the Customer device might transmit a pick-up code prearranged during placement of the Order, for example a media access control (MAC) address associated with the Customer device.

Similarly, if a Customer's schedule has changed, he has the opportunity to send a request to the Scheduler and the Terminal that the time, or even the Location, of fulfillment of his Order be changed.

Similarly, if an Order has been fulfilled early or its fulfillment has been delayed, the Terminal may alert the Customer device so that the Customer has an opportunity to adjust his schedule and arrival at the Location.

Similarly, the Scheduler can interrogate the Terminal and the Customer device for signs that Order fulfillment will fail, for example the Customer device is enroute to the wrong Location, and in response can either simply alert the Customer device and the Terminal or propose a modification to the Order to conform to current circumstances, for example transferring the fulfillment location of the Order to the Location the Customer device is heading toward.

Similarly, the Customer device and the Merchant Terminal might automatically or manually interrogate the other to confirm fulfillment is proceeding as planned, for example if the Customer device appears destined to arrive late or has not arrived on time at the Location.

The Customer may use this same communication pathway from his Customer device to acknowledge to the Terminal that the Order has been fulfilled, in which case the Terminal could send a Completed message back to the Scheduler to confirm successful completion of the transaction and its removal from the Queue. The Customer's Order fulfillment acknowledgement might include explicit feedback on the success of the Order or merely implicit feedback, such as the time of fulfillment for comparison with the time of placement.

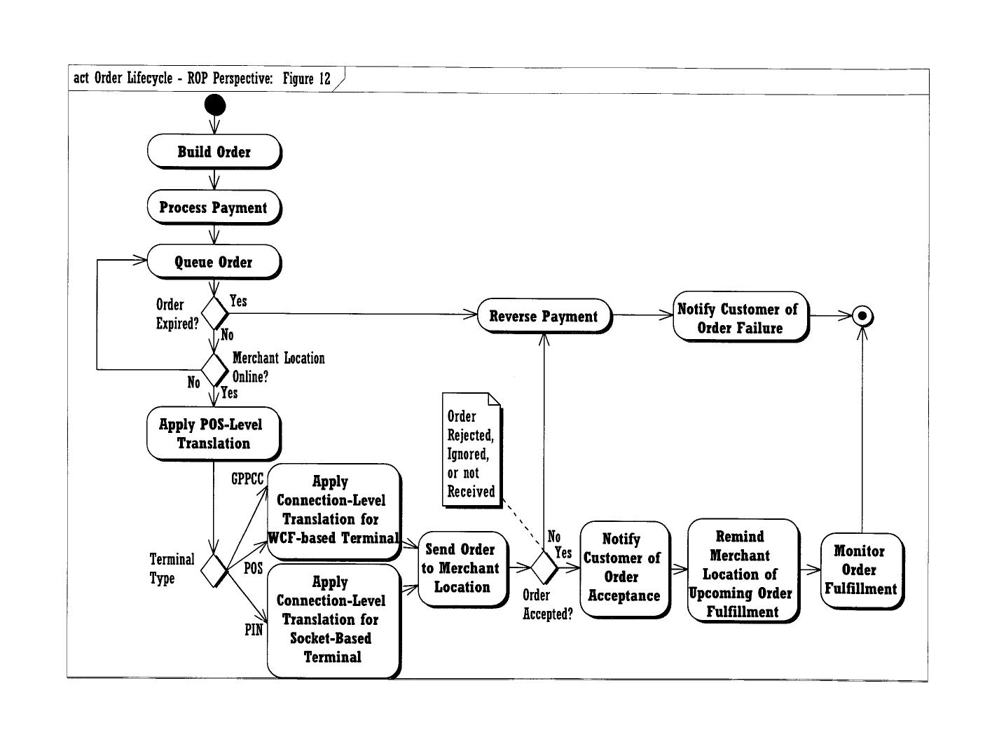

FIG. 12 shows an exemplary Order lifecycle from the perspective of the ROP.

In response to communication from a Customer at a Customer device indicating that he would like to place an order, the ROP builds an Order, wherein the Ordering Portal with recourse to the Database Server guides the Customer through preparation of a fulfillable Order through communications structured to comply with the Domain Model. In other words, the Order is compliant with the BusinessRules, includes only information that maps into the attributes and operations of the Domain Model classes, and includes all information the Domain Model requires for a fulfillable Order. Those skilled in the art will recognize that the Domain Model will vary with the nature of the business conducted, but might include information about characteristics of items ordered, quantities of items ordered, prices of items ordered, portions or complete payment to be made at specific points in the purchase and fulfillment flow, taxes, time and other characteristics of delivery, and the Customer.

Once the Order has been specified, the ROP might seek authorization or full payment against a payment account offered by the Customer. Again, those skilled in the art will recognize that decisions about risk, credit and creditworthiness will vary by Merchant and business and so this activity may be omitted or be different in some cases. Furthermore, Merchant may require portions or complete payment to be made at specific points in the purchase and fulfillment flow to accommodate risk, credit and the creditworthiness of the Customer.

Thereafter, the ROP Scheduler will queue the Order, taking note for example of when the Order should be sent to the intended Merchant Location and when the Order should be considered expired.

If the ROP detects that the intended Merchant Location is online at the time determined for sending the Order, it will send the Order. Otherwise it will requeue the Order and try sending again later until the Order is either sent or has expired.

If the Order expires before being sent, any processed payment will be reversed and the Customer will be notified that the Order has failed.

Otherwise, if the intended Terminal is online to receive the Order, the ROP will:
first apply appropriate POS-level translation to the Order to make the Order consistent with the data structure of whichever POS system, if any, the Locations package indicates is provisioned on the Terminal,
second apply appropriate connection-level translation to the Order consistent with the data structure expected by whichever connection the Locations package indicates is provisioned on the Terminal, and
send the Order to the Terminal.

If the ROP detects that the Terminal has accepted the Order, then the ROP will notify the Customer of Acceptance, if needed remind the Terminal of the upcoming Order fulfillment, and monitor whether the Terminal or the Customer confirms that the order has been fulfilled.

Alternatively, if the ROP does not detect that the Terminal has accepted the Order within a predetermined interval or if the ROP detects that the Terminal has rejected the Order, then the ROP will reverse any processed payment and notify the Customer that the Order has failed.

Those skilled in the art will recognize that these are just exemplary activities supported by the Network and the System. More generally, notifications and reminders may be exchanged between the Scheduler, the Merchant Terminal, the Customer device—and even other Merchant Terminals or Merchant Terminals at other Locations—during the pendency of an Order, for example to remind a soccer mom Customer that a postgame lunch Order placed last week will be fulfilled today, to alert a Merchant Location that an unusually large Order volume is due for fulfillment in two hours, or to guide a Merchant Location how best, in accordance with the BusinessRules, to prioritize Orders, parts of Orders, or tasks common to multiple Orders to best fulfill the currently pending Orders.

A rich set of notifications can be supported; depending on purchase occasion and fulfillment type there can be multiple communications between a Customer and a Merchant including but not limited to: order notification outside business hours, order notification inside business hours, prompt Merchant for order acceptance outside or during business hours, remind Merchant of timely fulfillment, prompt Merchant for change in order, prompt merchant for validation of fulfillment, prompt merchant for validation of completing payment For example, a scheduled order for delivery later in the day—but placed outside of business hours—may warrant an email/text to be sent to the Merchant in-advance of opening hours, so that for example a franchisee will know about a larger order as far in-advance as possible. However, for these larger orders there may be no practical way for the franchisee to review existing inventory, if for example he is at home in bed at 5:00 AM. In such case a series of notification could be helpful:
(A) A first notification can be sent to the Merchant of an incoming order that can be accepted, but more likely will trigger an automated response to the Customer that “We have received your order and will confirm you order within 60 minutes of our regular store hours.
(B) A second notification would be sent to the Merchant as soon as a Merchant Terminal connects with the ROP: a request for the Merchant Location to confirm if it will fulfill the order.
(C) A reminder third notification to the Merchant that an order is imminently due for delivery in a predetermined interval.
(D) A follow-up fourth notification to confirm successful delivery/fulfillment of the order, as to confirm that a delivery driver has fulfilled their obligations and as such, the Merchant has fulfilled their obligations.
(E) A possible fifth notification may prompt either the Customer or the Merchant for feedback on the purchase (was this Customer's address easy to deliver to? Did the Merchant provide fresh food in a timely manner?)

As described above, some Terminals may include a Robot API component that can parse portions of structured Order communications and direct processing equipment at the intended fulfillment location to assist in fulfilling the Order. For example, an accepted Order may activate a fountain drink dispenser to fulfill the beverage portion of the Order.

Those skilled in the art will recognize that FIGS. 11 and 12 and their description in particular, and the specification as a whole more generally, teach and illustrate a way of fulfilling an order for at least one of a good and a service by:
at a remote ordering platform (ROP) server, opening a first communication channel with a merchant terminal having a location, in response to receiving at the ROP server a request from the merchant terminal to open the first communication channel,
at the ROP server, opening a second communication channel with a customer device, in response to receiving at the ROP server a request from the customer device to open the second communication channel,
receiving at the ROP server an order for fulfillment from the customer device via the second communication channel,
sending the order from the ROP server to the merchant terminal via the first communication channel,
monitoring at the ROP server for receipt within a first threshold interval of an order acceptance message from the merchant terminal via the first communication channel,
in response to receiving at the ROP server an order acceptance message from the merchant terminal within the first threshold interval, sending an acceptance notification message from the ROP server to the customer device via the second communication channel, but in response to not receiving at the ROP server an order acceptance message from the merchant terminal within the first threshold interval, sending an order failure message from the ROP server to the customer device via the second communication channel,
in response to receiving at the ROP server an order acceptance message from the merchant terminal within the first threshold interval, monitoring at the ROP server for confirmation within a second threshold interval from at least one of the merchant terminal and the customer device of order fulfillment at the location, and
in response to receiving at the ROP server confirmation within the second threshold interval of order fulfillment, closing the second communication channel, but in response to not receiving at the ROP server confirmation within the second threshold interval of order fulfillment, sending an order failure message from the ROP server to the customer device via the second communication channel,
wherein opening the first communication channel and/or the second communication channel may include opening a managed communication channel and/or connecting sockets,
wherein opening the first communication channel may include selecting a connection-level translation in response to the type of merchant terminal,
wherein sending the order may include queuing the order at the ROP server and sending the queued order, and
wherein monitoring at the ROP server for confirmation within a second threshold interval from at least one of the merchant terminal and the customer device of order fulfillment at the location, may further include in response to not receiving at the ROP server confirmation of order fulfillment within a third interval shorter than the second threshold interval, sending a reminder message from the ROP server to the merchant terminal via the first communication channel.

In this arrangement, at least one of the good and the service is physically changed either by, or in response to, or as a result of fulfillment of the order.

Those skilled in the art will appreciate that this arrangement provides for changes in the location of the merchant terminal device in the period between the time of order acceptance and the time of order fulfillment and that during that period the ROP server may receive order updates from at least one of the customer device and the merchant terminal device, and the ROP server may transmit order reminders to at least one of the customer device and the merchant terminal device. In this regard, the ROP server may relay order updates to at least one of the merchant terminal device and the customer device or may mediate such order updates. Such an order update may include: a proximity of the customer device to the location, an estimated time until the order is ready for fulfillment, a change in the location, or a change in the order. More broadly, proximity may be evaluated between any node and a physical location or between any two or more nodes, and might be implemented for example using geo-fencing or beacon arrangements, and may consider direction, speed, acceleration, time and other measures.

Those skilled in the art will appreciate that receiving an order includes building the order and processing payment for the order, and furthermore that building the order includes negotiating the order. Where an order cannot be completed, sending an order failure message from the ROP server to the customer device via the second communication channel includes processing a reverse payment for the order and either rebuilding the order or closing the second communication channel.

### (d) Description Summary

Thus, it will be seen from the foregoing embodiments and examples that there has been described a way to provide computing and communication infrastructure to support full duplex quality of service for urgent and actionable structured communications securely transacted over a many-to-many managed network of intermittent ad hoc nodes.

While specific embodiments of the invention have been described and illustrated, such embodiments should be considered illustrative of the invention only and not as limiting the invention. In particular, all quantities described have been determined empirically and those skilled in the art might well expect a wide range of values surrounding those described to provide similarly beneficial results.

It will be understood by those skilled in the art that various changes, modifications and substitutions can be made to the foregoing embodiments without departing from the principle and scope of the invention expressed in the claims made herein.

While the invention has been described as having particular application for quick service restaurants, those skilled in the art will recognize it has wider application.

What is claimed is:

1. A method of fulfilling an order for at least one of a good and a service, comprising:
a. at a remote ordering platform (ROP) server, opening a first communication channel with a merchant terminal having a location, in response to receiving at the ROP server a request from the merchant terminal to open the first communication channel,
b. at the ROP server, opening a second communication channel with a customer device, in response to receiving at the ROP server a request from the customer device to open the second communication channel,
c. receiving at the ROP server an order for fulfillment from the customer device via the second communication channel,
d. sending the order from the ROP server to the merchant terminal via the first communication channel,
e. monitoring at the ROP server for receipt within a first threshold interval of an order acceptance message from the merchant terminal via the first communication channel,
f. in response to receiving at the ROP server an order acceptance message from the merchant terminal within the first threshold interval, sending an acceptance notification message from the ROP server to the customer device via the second communication channel, but in response to not receiving at the ROP server an order acceptance message from the merchant terminal within the first threshold interval, sending an order failure message from the ROP server to the customer device via the second communication channel,
g. in response to receiving at the ROP server an order acceptance message from the merchant terminal within the first threshold interval, monitoring at the ROP server for confirmation within a second threshold interval from at least one of the merchant terminal and the customer device of order fulfillment at the location, and
h. in response to receiving at the ROP server confirmation within the second threshold interval of order fulfillment, closing the second communication channel, but in response to not receiving at the ROP server confirmation within the second threshold interval of order fulfillment, sending an order failure message from the ROP server to the customer device via the second communication channel.

2. A method as claimed in claim 1, wherein the location of the merchant device can change between the time of order acceptance and the time of order fulfillment.

3. A method as claimed in claim 1, further comprising, between the time of order acceptance and the time of order fulfillment, at least one of:
a. receiving at the ROP server order updates from at least one of the customer device and the merchant terminal, and
b. transmitting from the ROP server order reminders to at least one of the customer device and the merchant terminal.

4. A method as claimed in claim 3, wherein receiving at the ROP server order updates includes relaying from the ROP server order updates to at least one of the merchant terminal and the customer device.

5. A method as claimed in claim 4, wherein relaying from the ROP server order updates includes mediating order updates.

6. A method as claimed in claim 3, wherein updates include at least one of:
a. a proximity of the customer device to the location,
b. an estimated time until the order is ready for fulfillment,
c. a change in the location, and
d. a change in the order.

7. A method as claimed in claim 1, wherein receiving an order includes building the order.

8. A method as claimed in claim 7, wherein building the order includes negotiating the order.

9. A method as claimed in claim 1, wherein receiving the order includes processing payment for the order.

10. A method as claimed in claim 9, wherein sending an order failure message from the ROP server to the customer device via the second communication channel includes processing a reverse payment for the order.

11. A method as claimed in claim 10, wherein processing a reverse payment includes closing the second communication channel.

12. A method as claimed in claim 1, wherein sending an order failure message from the ROP server to the customer device via the second communication channel includes rebuilding the order.

13. A method as claimed in claim 1, further including queuing the order at the ROP server.

14. A method as claimed in claim 13, wherein sending the order includes sending the queued order.

15. A method as claimed in claim 1, wherein monitoring at the ROP server for confirmation within a second threshold interval from at least one of the merchant terminal and the customer device of order fulfillment at the location, further includes in response to not receiving at the ROP server confirmation of order fulfillment within a third interval shorter than the second threshold interval, sending a reminder message from the ROP server to the merchant terminal via the first communication channel.

16. A method as claimed in claim 1, wherein opening a first communication channel includes selecting a connection-level translation in response to the type of the merchant terminal.

17. A method as claimed in claim 1, wherein at least one of the good and the service is physically changed at least one of:
a. by,
b. in response to, and
c. as a result of,
fulfillment of the order.

18. A method as claimed in claim 1, wherein at least one of opening a first communication channel and opening a second communication channel includes opening a managed communication channel.

19. A method as claimed in claim 1, wherein at least one of opening a first communication channel and opening a second communication channel includes connecting sockets.

20. A method of connecting a merchant terminal to a remote ordering platform (ROP) server for communication therebetween, the ROP server having a load balancer and a plurality of distributed hosts, comprising:
a. sending from the merchant terminal a GetHostList message to the load balancer,
b. at the merchant terminal, receiving from the load balancer a PriorityListofHosts message that provides a plurality of uniform resource identifiers respectively associated with the plurality of distributed hosts, the plurality of uniform resource identifiers being prioritized such that higher priority uniform resource identifier are more likely than lower priority uniform resource identifiers to represent an efficient connection,
c. in order of priority, sending from the merchant terminal an authorization request to the one of the plurality of distributed hosts associated with a one of the plurality of uniform resource identifiers and waiting a first interval to receive an authentication acknowledgement, and
i. if an authentication acknowledgement is received within the first interval, opening a connection with that one of the plurality of distributed hosts, but
ii. if an authentication acknowledgement is not received within the first interval, repeating step c. with the next highest priority one of the plurality of uniform resource identifiers, but
iii. if an authentication acknowledgement is not received within the first interval and there is not an untried one of the plurality of uniform resource identifiers, then repeating step a., and
d. if a connection with one of the plurality of distributed hosts has been opened, monitoring at the merchant terminal for a periodic KeepAlive message from the one of the plurality of distributed hosts and in response sending to the one of the plurality of distributed hosts an Okay acknowledgement to keep open the communication channel.

21. A method as claimed in claim 20, wherein monitoring at the merchant terminal for a periodic KeepAlive message from the one of the plurality of distributed hosts includes monitoring for a second interval and in response to not receiving a periodic KeepAlive message from the one of the plurality of distributed hosts within the second interval, sending from the merchant terminal an authorization request to the one of the plurality of distributed hosts and waiting a third interval to receive an authentication acknowledgement.

22. A method as claimed in claim 21, wherein waiting a third interval to receive an authentication acknowledgement includes, in response to not receive an authentication acknowledgement within the third interval, sending from the merchant terminal a GetHostList message to the load balancer.

23. A method as claimed in claim 22, wherein in response to not receive an authentication acknowledgement within the third interval, sending from the merchant terminal a GetHostList message to the load balancer, includes receiving from the load balancer a PriorityListofHosts message that provides a plurality of uniform resource identifiers respectively associated with the plurality of distributed hosts and ignoring the one of the plurality of uniform resource identifiers associated with the one of the plurality of distributed hosts.

24. A method as claimed in claim 20, wherein opening the connection includes sending to the one of the plurality of distributed hosts information about the merchant terminal as required to configure connection-level translation at the one of the plurality of distributed hosts.

25. A method as claimed in claim 20, wherein opening the connection includes opening a managed connection.

26. A method as claimed in claim 20, wherein opening the connection includes connecting sockets.

27. A method of connecting a merchant terminal to a remote ordering platform (ROP) server for communication therebetween over a network, the ROP server having a load balancer and a plurality of distributed hosts, comprising:
a. receiving at the load balancer a GetHostList message from the merchant terminal,
b. sending from the load balancer to the merchant terminal a PriorityListofHosts message that provides a plurality of uniform resource identifiers respectively associated with the plurality of distributed hosts, the plurality of uniform resource identifiers being prioritized such that higher priority uniform resource identifier are more likely than lower priority uniform resource identifiers to represent an efficient connection,
c. in order of priority, receiving from the merchant terminal an authorization request at a one of the plurality of distributed hosts associated with a one of the plurality of uniform resource identifiers, sending an authentication acknowledgement to the merchant terminal, and opening a connection with the merchant terminal, and
d. sending from the one of the plurality of distributed hosts to the merchant terminal a periodic KeepAlive message and in response to receiving an Okay acknowledgement within a first interval keeping open the communication channel but in response to not receiving an Okay acknowledgement within the first interval closing the communication channel.

28. A method as claimed in claim 27, further including periodically sending from at least one of the load balancer and one of the plurality of distributed hosts a Probe message and monitoring for receipt within a second interval of a ProbeStatus acknowledgement.

29. A method as claimed in claim 27, further including, in response to not receiving within the second interval a ProbeStatus acknowledgement, closing any open communication channel between the one of the plurality of distributed hosts and any merchant terminal and removing from the PriorityListofHosts any uniform resource identifier associated with the one of the plurality of distributed hosts.

30. A method as claimed in claim 27, further including periodically sending from the one of the plurality of distributed hosts to each of the other of the plurality of distributed hosts a respective HealthCheck message and monitoring for receipt within a third interval of a respective HealthCheckStatus acknowledgement.

31. A method as claimed in claim 30, further including, in response to not receiving within the third interval a HealthCheckStatus acknowledgement from another one of the plurality of distributed hosts, closing any open communication channel between the other one of the plurality of distributed hosts and any merchant terminal and removing from the PriorityListofHosts any uniform resource identifier associated with the other one of the plurality of distributed hosts.

32. A method as claimed in claim 27, wherein opening the connection includes selecting connection-level translation appropriate for the merchant terminal.

33. A method as claimed in claim 27, wherein opening the connection includes opening a managed connection.

34. A method as claimed in claim 27, wherein opening the connection includes connecting sockets.

35. A method as claimed in claim 27, further comprising correlating business and technical metrics for a portion of the network over a period of time.

36. An apparatus for providing a remote ordering platform (ROP), comprising:
a. a database server operable to retrievably store information related to an order,
b. an ordering portal node, operable to receive the order from a customer device,
c. a scheduler node, operable to schedule the received order, and
d. a host node, operable to send the scheduled order to a merchant terminal.

37. An apparatus as claimed in claim 36, wherein at least one of the ordering portal node and the host node includes a communication socket operable to maintain a communication channel with the customer device and the merchant terminal respectively.

38. An apparatus as claimed in claim 37, wherein operable to maintain a communication channel includes operable to open a communication channel in response to receiving a request.

39. An apparatus as claimed in claim 36, wherein the database server includes a database management system operable to manage packages of objects, including:
a. a Products package,
b. a Locations package,
c. a Customers package,
d. an Orders package,
e. a Queues package, and
f. a Business Rules package.

40. An apparatus as claimed in claim 39, wherein the Orders package includes:
a. an OrderOptionAttributes class,
b. an OrderProductOptions class which is an aggregation of the OrderOptionAttributes class,
c. an OrderProducts class, which is an aggregation of the OrderProductOptions class,
d. a LocationTaxes class,
e. an OrderTaxes class,
f. a Taxes class, which is a generalization of the LocationTaxes class and the OrderTaxes class, and
g. an Orders class, which is an aggregation of the Taxes class and a generalization of the OrderProducts class.

41. An apparatus as claimed in claim 40, wherein the Products package includes:
a. an Attributes class, which is a generalization of the OrderOptionsAttributes class,
b. an Options class, which is an aggregation of the Attributes class and a generalization of the OrderProductsOptions class,
c. a LocationProducts class, and
d. a Products class, which is an aggregation of the Options class and a generalization of the LocationsProducts class and which is associated with the OrderProducts class.

42. An apparatus as claimed in claim 41, wherein the Customer package includes a Customers class, which is an aggregation of the Orders class.

43. An apparatus as claimed in claim 42, wherein the Queue package includes:
a. a QueueEntries class associated with the Orders class, and
b. a Schedulers class, associated with the QueueEntries class.

44. An apparatus as claimed in claim 43, wherein the Business Rules package includes a BusinessRules class associated with the Orders class.

45. An apparatus as claimed in claim 44, wherein the Locations package includes:
a. a Locations class associated with the Orders class, the LocationTaxes class and the LocationProducts class,
b. a Terminals class associated with the Locations class, and
c. a Hosts class associated with the Terminals class.

46. An apparatus as claimed in claim 45, wherein the Locations package further includes:
a. a POSTerminals class,
b. a StandaloneTerminals class,
c. a PCTerminals class, which is a generalization of the POSTerminals class and the StandaloneTerminals class, and
d. a PINTerminals class,
wherein the Terminals class is a generalization of the PCTerminals class and the PINTerminals class.

47. An apparatus as claimed in claim 46, wherein the Locations package further includes:
a. a SocketHostInterface class,
b. a WCFHostInterface class, and
c. a HostInterface class, which is a generalization of the SocketHostInterface class and the WCFHostInterface class,
wherein the Hosts class is an aggregation of the HostInterface class.

48. An apparatus as claimed in claim 36, wherein the ordering portal node includes at least one of a web server component and a mobile application component.

49. An apparatus as claimed in claim 36, wherein the scheduler node includes a scheduling and queuing service component.

50. An apparatus as claimed in claim 36, wherein the host node includes an authentication and routing service component.

51. An apparatus as claimed in claim 36, wherein the ROP further includes at least one of:
a. a POS component, and
b. a PIN component.

52. An apparatus as claimed in claim 36, wherein the ROP is hosted at a gateway node.

53. An apparatus as claimed in claim 52, wherein the gateway node is hosted at a processor node.

54. An apparatus as claimed in claim 53, wherein the processor node is hosted at an acquirer node.

55. An apparatus for providing a merchant terminal for communication with a remote ordering platform (ROP) server, comprising:
a. a computing and communication device having:
i. a processor,
ii. a memory for storing code for instructing the processor, and
iii. a communication socket, and
b. ROP API component code stored in the memory to instruct the processor in communication with the ROP server via the communication socket.

56. An apparatus as claimed in claim 55, wherein the computing and communication device at least one of has a PIN device and is a PIN device.

57. An apparatus as claimed in claim 55, wherein the computing and communication device at least one of has a POS device and is a POS device.

58. An apparatus as claimed in claim 55, wherein the computing and communication device is a customer device.

59. An apparatus as claimed in claim 58, further including VPOS component code stored in the memory to instruct the processor to perform the functions of a virtual point of sale device.

60. An apparatus as claimed in claim 55, further including Robot API component code stored in the memory to instruct the processor to direct processing equipment to assist with order fulfillment.

61. A medium encoding instructions, which are readable and executable by a computing or communication device, for performing a method of fulfilling an order for at least one of a good and a service, comprising:
a. at a remote ordering platform (ROP) server, opening a first communication channel with a merchant terminal having a location, in response to receiving at the ROP server a request from the merchant terminal to open the first communication channel,
b. at the ROP server, opening a second communication channel with a customer device, in response to receiving at the ROP server a request from the customer device to open the second communication channel,
c. receiving at the ROP server an order for fulfillment from the customer device via the second communication channel,
d. sending the order from the ROP server to the merchant terminal via the first communication channel,
e. monitoring at the ROP server for receipt within a first threshold interval of an order acceptance message from the merchant terminal via the first communication channel,
f. in response to receiving at the ROP server an order acceptance message from the merchant terminal within the first threshold interval, sending an acceptance notification message from the ROP server to the customer device via the second communication channel, but in response to not receiving at the ROP server an order acceptance message from the merchant terminal within the first threshold interval, sending an order failure message from the ROP server to the customer device via the second communication channel,
g. in response to receiving at the ROP server an order acceptance message from the merchant terminal within the first threshold interval, monitoring at the ROP server for confirmation within a second threshold interval from at least one of the merchant terminal and the customer device of order fulfillment at the location, and
h. in response to receiving at the ROP server confirmation within the second threshold interval of order fulfillment, closing the second communication channel, but in response to not receiving at the ROP server confirmation within the second threshold interval of order fulfillment, sending an order failure message from the ROP server to the customer device via the second communication channel.

62. A medium as claimed in claim 61, wherein the location of the merchant device can change between the time of order acceptance and the time of order fulfillment.

63. A medium as claimed in claim 61, wherein the method further includes, between the time of order acceptance and the time of order fulfillment, at least one of:
a. receiving at the ROP server order updates from at least one of the customer device and the merchant terminal, and
b. transmitting from the ROP server order reminders to at least one of the customer device and the merchant terminal.

64. A medium as claimed in claim 63, wherein the method further includes receiving at the ROP server order updates includes relaying from the ROP server order updates to at least one of the merchant terminal and the customer device.

65. A medium as claimed in claim 64, wherein the method further includes relaying from the ROP server order updates includes mediating order updates.

66. A medium as claimed in claim 63, wherein updates include at least one of:
a. a proximity of the customer device to the location,
b. an estimated time until the order is ready for fulfillment,
c. a change in the location, and
d. a change in the order.

67. A medium as claimed in claim 61, wherein receiving an order includes building the order.

68. A medium as claimed in claim 67, wherein building the order includes negotiating the order.

69. A medium as claimed in claim 61, wherein receiving the order includes processing payment for the order.

70. A medium as claimed in claim 69, wherein sending an order failure message from the ROP server to the customer device via the second communication channel includes processing a reverse payment for the order.

71. A medium as claimed in claim 70, wherein processing a reverse payment includes closing the second communication channel.

72. A medium as claimed in claim 61, wherein sending an order failure message from the ROP server to the customer device via the second communication channel includes rebuilding the order.

73. A medium as claimed in claim 61, wherein the method further includes queuing the order at the ROP server.

74. A medium as claimed in claim 73, wherein sending the order includes sending the queued order.

75. A medium as claimed in claim 61, wherein monitoring at the ROP server for confirmation within a second threshold interval from at least one of the merchant terminal and the customer device of order fulfillment at the location, further includes in response to not receiving at the ROP server confirmation of order fulfillment within a third interval shorter than the second threshold interval, sending a reminder message from the ROP server to the merchant terminal via the first communication channel.

76. A medium as claimed in claim 61, wherein opening a first communication channel includes selecting a connection-level translation in response to the type of the merchant terminal.

77. A medium as claimed in claim 61, wherein at least one of the good and the service is physically changed at least one of:
a. by,
b. in response to, and
c. as a result of,
fulfillment of the order.

78. A medium as claimed in claim 61, wherein at least one of opening a first communication channel and opening a second communication channel includes opening a managed communication channel.

79. A medium as claimed in claim 61, wherein at least one of opening a first communication channel and opening a second communication channel includes connecting sockets.

80. A medium encoding instructions, which are readable and executable by a computing or communication device, for performing a method of connecting a merchant terminal to a remote ordering platform (ROP) server for communication therebetween, the ROP server having a load balancer and a plurality of distributed hosts, comprising:
a. sending from the merchant terminal a GetHostList message to the load balancer,
b. at the merchant terminal, receiving from the load balancer a PriorityListofHosts message that provides a plurality of uniform resource identifiers respectively associated with the plurality of distributed hosts, the plurality of uniform resource identifiers being prioritized such that higher priority uniform resource identifier are more likely than lower priority uniform resource identifiers to represent an efficient connection,
c. in order of priority, sending from the merchant terminal an authorization request to the one of the plurality of distributed hosts associated with a one of the plurality of uniform resource identifiers and waiting a first interval to receive an authentication acknowledgement, and
i. if an authentication acknowledgement is received within the first interval, opening a connection with that one of the plurality of distributed hosts, but
ii. if an authentication acknowledgement is not received within the first interval, repeating step c. with the next highest priority one of the plurality of uniform resource identifiers, but
iii. if an authentication acknowledgement is not received within the first interval and there is not an untried one of the plurality of uniform resource identifiers, then repeating step a., and
d. if a connection with one of the plurality of distributed hosts has been opened, monitoring at the merchant terminal for a periodic KeepAlive message from the one of the plurality of distributed hosts and in response sending to the one of the plurality of distributed hosts an Okay acknowledgement to keep open the communication channel.

81. A medium as claimed in claim 80, wherein monitoring at the merchant terminal for a periodic KeepAlive message from the one of the plurality of distributed hosts includes monitoring for a second interval and in response to not receiving a periodic KeepAlive message from the one of the plurality of distributed hosts within the second interval, sending from the merchant terminal an authorization request to the one of the plurality of distributed hosts and waiting a third interval to receive an authentication acknowledgement.

82. A medium as claimed in claim 81, wherein waiting a third interval to receive an authentication acknowledgement includes, in response to not receive an authentication acknowledgement within the third interval, sending from the merchant terminal a GetHostList message to the load balancer.

83. A medium as claimed in claim 82, wherein the method further includes in response to not receive an authentication acknowledgement within the third interval, sending from the merchant terminal a GetHostList message to the load balancer, includes receiving from the load balancer a PriorityListofHosts message that provides a plurality of uniform resource identifiers respectively associated with the plurality of distributed hosts and ignoring the one of the plurality of uniform resource identifiers associated with the one of the plurality of distributed hosts.

84. A medium as claimed in claim 80, wherein opening the connection includes sending to the one of the plurality of distributed hosts information about the merchant terminal as required to configure connection-level translation at the one of the plurality of distributed hosts.

85. A medium as claimed in claim 80, wherein opening the connection includes opening a managed connection.

86. A medium as claimed in claim 80, wherein opening the connection includes connecting sockets.

87. A medium encoding instructions, which are readable and executable by a computing or communication device, for performing a method of connecting a merchant terminal to a remote ordering platform (ROP) server for communication therebetween over a network, the ROP server having a load balancer and a plurality of distributed hosts, comprising:
a. receiving at the load balancer a GetHostList message from the merchant terminal,
b. sending from the load balancer to the merchant terminal a PriorityListofHosts message that provides a plurality of uniform resource identifiers respectively associated with the plurality of distributed hosts, the plurality of uniform resource identifiers being prioritized such that higher priority uniform resource identifier are more likely than lower priority uniform resource identifiers to represent an efficient connection,
c. in order of priority, receiving from the merchant terminal an authorization request at a one of the plurality of distributed hosts associated with a one of the plurality of uniform resource identifiers, sending an authentication acknowledgement to the merchant terminal, and opening a connection with the merchant terminal, and
d. sending from the one of the plurality of distributed hosts to the merchant terminal a periodic KeepAlive message and in response to receiving an Okay acknowledgement within a first interval keeping open the communication channel but in response to not receiving an Okay acknowledgement within the first interval closing the communication channel.

88. A medium as claimed in claim 87, wherein the method further includes periodically sending from at least one of the load balancer and one of the plurality of distributed hosts a Probe message and monitoring for receipt within a second interval of a ProbeStatus acknowledgement.

89. A medium as claimed in claim 88, wherein the method further includes in response to not receiving within the second interval a ProbeStatus acknowledgement, closing any open communication channel between the one of the plurality of distributed hosts and any merchant terminal and removing from the PriorityListofHosts any uniform resource identifier associated with the one of the plurality of distributed hosts.

90. A medium as claimed in claim 87, wherein the method further includes periodically sending from the one of the plurality of distributed hosts to each of the other of the plurality of distributed hosts a respective HealthCheck message and monitoring for receipt within a third interval of a respective HealthCheckStatus acknowledgement.

91. A medium as claimed in claim 90, wherein the method further includes in response to not receiving within the third interval a HealthCheckStatus acknowledgement from another one of the plurality of distributed hosts, closing any open communication channel between the other one of the plurality of distributed hosts and any merchant terminal and removing from the PriorityListofHosts any uniform resource identifier associated with the other one of the plurality of distributed hosts.

92. A medium as claimed in claim 87, wherein opening the connection includes selecting connection-level translation appropriate for the merchant terminal.

93. A medium as claimed in claim 87, wherein opening the connection includes opening a managed connection.

94. A medium as claimed in claim 87, wherein opening the connection includes connecting sockets.

95. A medium as claimed in claim 87, wherein the method further includes correlating business and technical metrics for a portion of the network over a period of time.
